(19) United States
(12) Patent Application Publication
(10) Pub. No.: US 2018/0076992 A1
(43) Pub. Date: Mar. 15, 2018

(54) WIRELESS COMMUNICATION DEVICE AND WIRELESS COMMUNICATION METHOD

(71) Applicant: KABUSHIKI KAISHA TOSHIBA, Tokyo (JP)

(72) Inventors: Toshihisa NABETANI, Kawasaki (JP); Kentaro TANIGUCHI, Kawasaki (JP); Ryoko MATSUO, Tokyo (JP); Tsuguhide AOKI, Kawasaki (JP)

(73) Assignee: KABUSHIKI KAISHA TOSHIBA, Tokyo (JP)

(21) Appl. No.: 15/457,262

(22) Filed: Mar. 13, 2017

(30) Foreign Application Priority Data
Sep. 15, 2016 (JP) 2016-180765

(51) Int. Cl. H04L 27/26

(52) U.S. Cl. CPC H04L 27/26; H04W 84/12

(57) ABSTRACT

According to one embodiment, a wireless communication device includes a receiver and a transmitter. The receiver receives N pieces of first data transmitted by N terminals in a multiplexed manner; generates combined data by combining a piece of second data with one of the N pieces of first data; decodes the N pieces of first data by using N decode processors selected from among M decode processors where M is an integer larger than N; and decodes the combined data by using a first decode processor, among the M decode processors, other than the N decode processors.

### CROSS-REFERENCE TO RELATED APPLICATIONS

This application is based upon and claims the benefit of priority from Japanese Patent Application No. 2016-180765, filed on Sep. 15, 2016; the entire contents of which are incorporated herein by reference.

### FIELD

Embodiments of the present invention are related to a wireless communication device and a wireless communication method.

### BACKGROUND

A hybrid automatic re-transmission control called an Automatic Repeat Request (ARQ) is known by which, when an error is detected in a packet received from a transmitter, a receiver improves the quality of signals by combining reliability information (likelihood information) of a packet retransmitted from the transmitter with likelihood information of the initially-received packet.

For wireless Local Area Networks (LANs), the hybrid ARQ (hereinafter, “HARQ”) is not defined as a protocol. Accordingly, the timing with which the packet is retransmitted is dependent on functions actually installed. For this reason, there is no guarantee that the packet received following the packet from which the error was detected is a packet addressed to the reception device. Further, even when the packet is addressed to the reception device, there is no guarantee that the packet is a retransmitted packet. The reception device is therefore not able to understand the timing with which the retransmitted packet subject to the combining process is to be received.

In the situation where the received packet is not a retransmitted packet (i.e., is a new packet), when the likelihood information of the received packet is combined with the likelihood information of the packet from which the error was detected, it means, unfortunately, that the pieces of likelihood information of the packets having mutually-different bit sequences are combined. Consequently, the likelihood information resulting from the combining process is degraded. In that situation, a result of a check process (e.g., a Cyclic Redundancy Code (CRC) check) performed on the data obtained by decoding the combined likelihood information will be indicated as an error (“not OK”).

Another method is also possible by which it is conjectured whether or not the received packet is a packet subject to the combining process, i.e., whether or not the received packet is a retransmitted packet, so that the decode process can be varied according to the result of the conjecture. More specifically, when the packet is determined not to be a retransmitted packet, the received packet is decoded as it is. On the contrary, when the packet is determined to be a retransmitted packet, a decode process is performed by using a result obtained by combining the likelihood information of the packet received at this time, with the likelihood information of the packet that was previously received and exhibited “not OK” as a CRC check result. However, wireless LANs have a temporal restriction where a response with an acknowledgment needs to be transmitted when a Short Interframe Space (SIFS) time period (=16 μs) has elapsed since the reception of a packet. Accordingly, when the abovementioned method is used, there is a possibility that the acknowledgment response may not be transmitted in a timely fashion.

### BRIEF DESCRIPTION OF THE DRAWINGS

FIG. 1 is a drawing illustrating a wireless communication system including a base station and a plurality of terminals;

FIG. 2 is a drawing illustrating an example of a basic format of a MAC frame;

FIG. 3 is a drawing illustrating an example of a format of a packet;

FIG. 4 is a functional block diagram of a wireless communication device according to an embodiment of the present invention;

FIG. 5 is a diagram illustrating an exemplary configuration of a combining processor;

FIG. 6 is a table illustrating a relationship between CRC check results and classifications as to whether a packet is a retransmitted packet or a new packet;

FIG. 7 is a drawing of a flowchart illustrating an example of an operation performed by a base station according to the embodiment of the present invention;

FIG. 8 is a drawing illustrating an exemplary sequence of a wireless communication system according to the embodiment of the present invention;

FIG. 9 is a drawing illustrating an example of a packet containing an aggregation frame;

FIG. 10 is a functional block diagram of a wireless communication device according to another embodiment of the present invention;

FIG. 11 is a drawing illustrating an example in which whether a packet is a retransmitted packet or a new packet is determined by comparing likelihood information;

FIG. 12 is a drawing illustrating an example of a format of a trigger frame;

FIG. 13 is a drawing for explaining a Multi-STA BA frame;

FIG. 14 is a drawing for explaining an allocation of resource units;

FIG. 15 is a drawing for explaining a form of the resource units;

FIG. 16 is a drawing for explaining a concept of UL-MU-MIMO;

FIG. 17 is a drawing for explaining a preamble used in UL-MU-MIMO;

FIG. 18 is a functional block diagram of either a base station or a terminal according to a second embodiment;

FIG. 19 is a diagram illustrating an exemplary overall configuration of either a terminal or a base station according to a third embodiment;

FIG. 20 is a diagram illustrating an exemplary hardware configuration of a wireless LAN module installed in either the terminal or the base station according to the third embodiment;

FIG. 21 is a perspective view of a wireless communication terminal according to an embodiment of the present invention;

FIG. 22 is a drawing illustrating a memory card according to an embodiment of the present invention; and

FIG. 23 is a drawing illustrating an example of a frame exchange process performed during a contention time period.

### DETAILED DESCRIPTION

According to one embodiment, a wireless communication device includes a receiver and a transmitter. The receiver receives N pieces of first data transmitted by N terminals in a multiplexed manner; generates combined data by combining a piece of second data with one of the N pieces of first data; decodes the N pieces of first data by using N decode processors selected from among M decode processors where M is an integer larger than N; and decodes the combined data by using a first decode processor, among the M decode processors, other than the N decode processors.

Embodiments of the present invention will be explained below, with reference to the accompanying drawings. IEEE Std 802.11 (TM)-2012 and IEEE Std 802.11ac (TM)-2013 that are known as standards of wireless LANs, as well as IEEE 802.11-15/0132r17 uploaded on May 25, 2016 and serving as a specification framework document for IEEE Std 802.11ax, which is a standard of next-generation wireless LANs, are incorporated by reference in its entirety in the present disclosure.

### First Embodiment

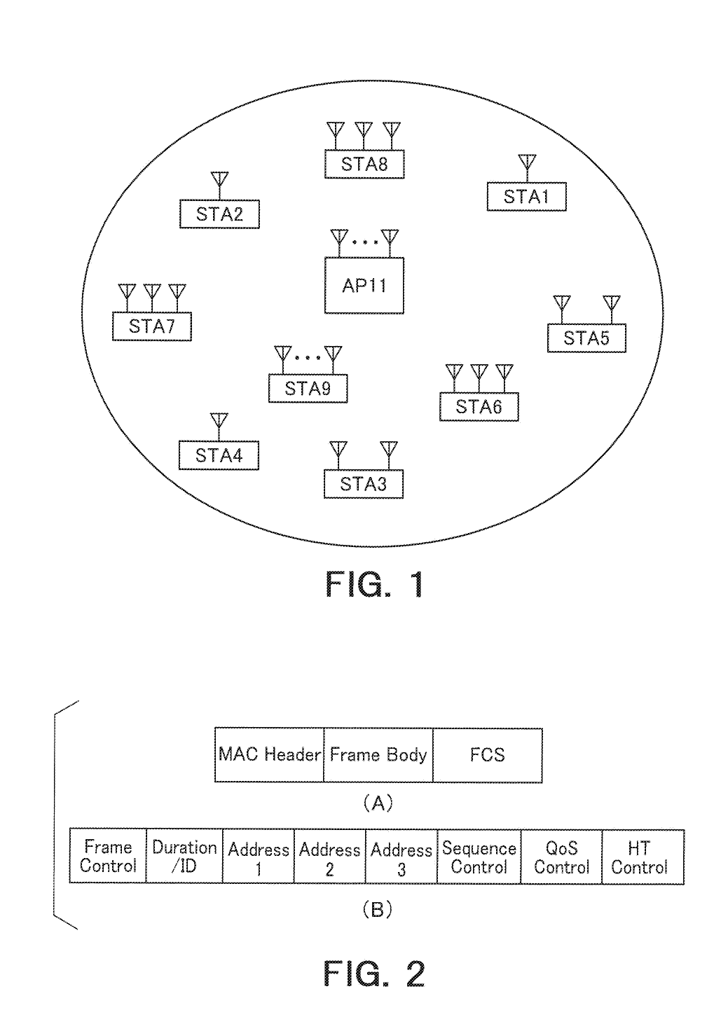

FIG. 1 illustrates a wireless communication system according to a first embodiment. The wireless communication system includes an Access Point (AP) 11 serving as a base station and wireless communication terminals (hereinafter, “terminals” or “stations”) 1 to 9. The access point 11 is considered to be a form of the terminals, because the access point 11 basically has the same functions as those of each of the terminals, except that the access point 11 has a relaying function. The access point 11 and the terminals 1 to 9 together structure a wireless LAN system compliant with the IEEE 802.11 standard using a Carrier Sense Multiple Access with Carrier Avoidance (CSMA/CA) scheme. The access point 11 and the terminals 1 to 9 each include a wireless communication device that performs communication compliant with the IEEE 802.11 standard. The wireless communication device installed in each of the terminals is configured to communicate with the wireless communication device installed in the access point. The wireless communication device installed in the access point is configured to communicate with the wireless communication device installed in any of the terminals. Another configuration is also acceptable in which the access point and the terminals perform communication with each other that is compliant with another communication scheme besides the communication scheme defined by the IEEE 802.11 standard.

One wireless communication group called a Basic Service Set (BSS) is formed as a result of the terminals (stations [STAs]) 1 to 9 each being connected to the access point 11. Being “connected” means being in a state of having a wireless link established. For the terminals 1 to 9, the wireless links are established as a result of completing exchanging parameters that are necessary for the communication, after performing an association process with the access point 11. After having established the wireless links, the terminals 1 to 9 belong to the BSS of the access point 11. The access point 11 may perform an authentication process with the terminals 1 to 9 prior to the association process.

The access point 11 includes at least one antenna. In the present example, the access point 11 includes a plurality of antennas. The wireless communication device included in the access point 11 is configured to transmit and receive packet data (which hereinafter may simply be referred to as a packet or a physical packet) containing MAC frames (which hereinafter may be referred to as frames) to and from the plurality of terminals 1 to 9, via the antennas. The wireless communication device included in the access point 11 includes: a wireless communicator that is connected to the antennas and is configured to transmit and receive the frames; and a controller configured to control the communication performed with the terminals via the wireless communicator.

Each of the terminals 1 to 9 includes one or more antennas. Each of the terminals has the wireless communication device installed therein. The wireless communication device included in each of the terminals is configured to transmit and receive the packet containing the frame to and from the access point 11, via the one or more antennas. The wireless communication device included in each of the terminals includes: a wireless communicator that is connected to the one or more antennas and is configured to transmit and receive the frame; and a controller configured to control the communication performed with the access point 11 via the wireless communicator.

The access point 11 forms either the BSS or a wireless network (called a first network) with the terminals. Further, in addition, the access point 11 may also be connected to another network (called a second network) that is wired, wireless, or a hybrid of the two. The access point 11 may be configured to relay communication between the first network and the second network. Further, the access point 11 may be configured to also relay communication among the plurality of terminals within the first network. The access point 11 may transmit the frame received from any of the terminals 1 to 9 to another terminal within the first network or to a second network, in accordance with the destination address indicated therein.

In the present embodiment, the access point 11 and two or more terminals selected from among the plurality of terminals 1 to 9 are able to perform communication according to an UpLink Multi-User (UL-MU) scheme. Examples of the UL-MU scheme include an uplink Orthogonal Frequency Division Multiple Access (OFDMA) scheme and an uplink MU-Multi-Input Multi-Output (MIMO) scheme. The uplink OFDMA scheme will be referred to as UL-OFDMA, whereas the uplink MU-MIMO scheme will be referred to as UL-MU-MIMO. The access point and the two or more of the terminals together may implement a scheme (UL-OFDMA & MU-MIMO) combining together UL-OFDMA and UL-MU-MIMO. The BSS of the access point 11 may include a legacy terminal, which is not compatible with UL-MU. The legacy terminal may be, more specifically, a terminal compatible with the standards of IEEE 802.11 a/b/g/n/ac. As other examples of the UL-MU scheme, a Code Division Multiple Access (CDMA) scheme or a Time Division Multiple Access (TDMA) scheme may be used.

In the present example, UL-MU-MIMO is a communication scheme by which the access point simultaneously receives packets transmitted from a plurality of terminals in a spatially multiplexed manner through a plurality of antennas and further separates the received signals into frames corresponding to the different terminals by performing a MIMO demodulation. The access point estimates a channel response of each of the uplinks formed with the terminals, by using a preamble signal contained at the head of the packet transmitted thereto from each of the terminals. The preamble signals are orthogonal to one another among the terminals. By using the channel responses, the access point spatially separates (decodes) the fields following the preamble signal in a correct manner. The preamble signals correspond to an example of a resource according to the present embodiment.

OFDMA is a scheme by which a plurality of resource units including one or more sub-carriers are allocated to a plurality of terminals, so that transmissions/receptions are simultaneously performed between the access point and the plurality of terminals. Each of the resource units is a frequency component serving as the smallest unit of resource used for performing the communication. The resource units correspond to an example of resources according to the present embodiment. In UL-OFDMA & MU-MIMO, a single resource unit is allocated to one or more terminals, so that UL-MU-MIMO is implemented in units of resource units. The resource units correspond to an example of the resources according to the present embodiment.

In contrast to the UL-MU scheme, another scheme by which each of the terminals individually performs communication with the access point is called a Single User (SU) scheme.

FIG. 2(A) illustrates an example of a basic format of a MAC frame used in the present embodiment. The frame format includes fields called a MAC header, a frame body, and an FCS. As illustrated in FIG. 2(B), the MAC header includes fields called Frame Control, Duration/ID, Address 1, Address 2, Address 3, Sequence Control, QoS Control, and High Throughput (HT) Control. Examples of types of frames include, in a general classification, data frames, management frames, and control frames. Any of these types of frames is based on the frame format illustrated in FIG. 2(A).

Not all the fields illustrated in FIG. 2(B) necessarily have to be present. One or more of the fields may not be present. For example, the Address 3 field may not be present in some situations. Further, one or both of the QoS Control field and the HT Control field may not be present in some situations. Further, the frame body field may not be present in some situations. Furthermore, other fields that are not illustrated in FIG. 2(B) may be present. For example, an Address 4 field may be present additionally. In a trigger frame described below, a common information field and a terminal information field may be present either in the frame body field or in the MAC header.

The Address 1 field contains a Receiver Address (RA), whereas the Address 2 field contains a Transmitter Address (TA). The Address 3 field contains either a Basic Service Set IDentifier (BSS ID) serving as an identifier of the BSS or a TA, depending on the purpose of the frame. The BSSID may be a wildcard BSSID (in which all the bits are “1”) that can work as any BSSID.

The Frame Control field includes two fields called Type and Subtype, or the like. The general classification as to whether a frame is a data frame, a management frame, or a control frame is defined by the Type field, whereas a smaller distinction within the generally-classified frame is defined by the Subtype field. For instance, examples of the control frame include a Block Ack (BA) frame, a Block Ack Request (BAR) frame, a Request to Send (RTS) frame, and a Clear to Send (CTS) frame. These frames are identified with reference to the Subtype field. The trigger frame (explained later) may also be identified according to combinations made up of types and subtypes. In one example, the trigger frame is classified as a control frame (of which the type is “control”).

The Duration/ID field has a medium reserved duration written therein. When a MAC frame addressed to another terminal is received, it is assessed that the medium is virtually busy from the end of the packet containing the MAC frame for the time length of the medium reserved duration. The system in which the medium is virtually assessed to be busy or the time period during which the medium is virtually considered to be busy is called a Network Allocation Vector (NAV) scheme. The QoS field is used for exercising QoS control where frames are transmitted while levels of priority are taken into consideration. The HT Control field is a field introduced in IEEE 802.11n. The High Throughput (HT) Control field is present when an order field is set to 1, while the data represents either QoS data or a management frame. The HT Control field may be extended into a Very High Throughput (VHT) Control field or a High Efficient (HE) Control field and is capable of issuing a notification corresponding to various types of functions defined in IEEE 802.11n, IEEE 802.11ac, and IEEE 802.11ax.

In the FCS field, Frame Check Sequence (FCS) information is configured as a check-sum code used for detecting an error in the frame on the reception side. Examples of the FCS information include a Cyclic Redundancy Code (CRC). In the present embodiment, it is assumed that a CRC is used.

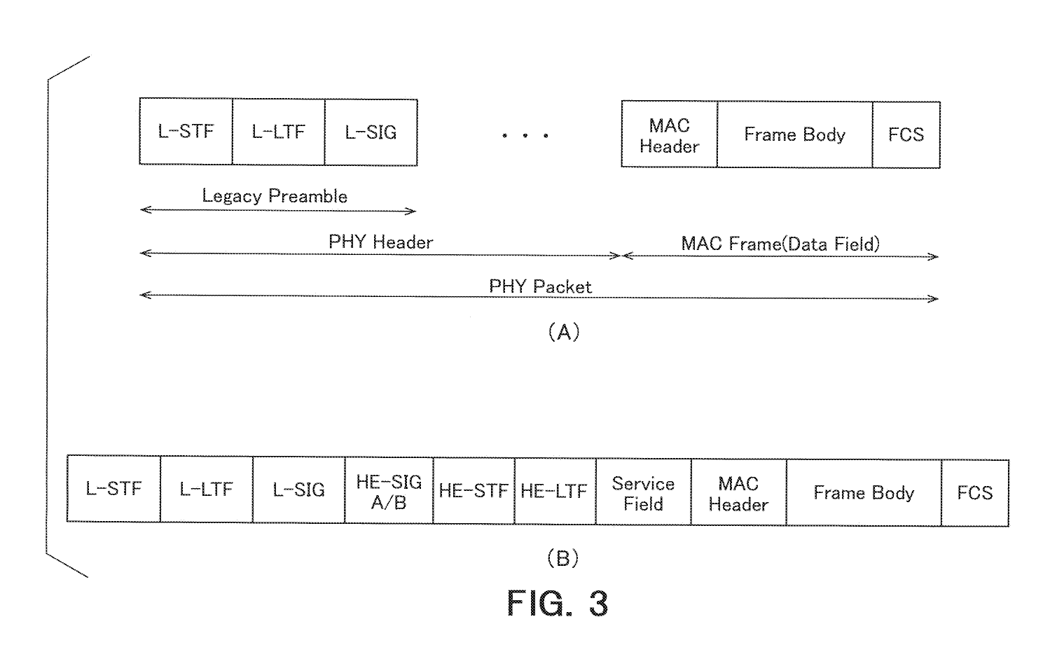

FIG. 3(A) illustrates an example of a format of a packet. A basic configuration of the packet is obtained by appending a physical header to a MAC frame stored in a data field. In an example, the physical header includes a Legacy-Short Training Field (L-STF), a Legacy-Long Training Field (L-LTF), and a Legacy Signal Field (L-SIG) that are defined in the IEEE 802.11 standard. The L-STF, the L-LTF, and the L-SIG are fields that are recognizable by a terminal based on a legacy standard such as IEEE 802.11a and store therein different types of information such as information about a signal detection, a frequency correction (a channel estimation), and a transfer speed (a transfer rate), respectively. The physical header may contain other fields that are not mentioned here (e.g., a field that is not recognizable by a terminal based on the legacy standard, but is recognizable by a UL-MU-compatible terminal). For example, HE-SIG-A (and HE-SIG-B), HE-STF, and HE-LTF, which are discussed in IEEE 802.11ax, may be contained. FIG. 3(B) illustrates an example of a format in which HE-SIG-A (and HE-SIG-B), HE-STF, and HE-LET are contained, as well as a service field that is further added. The service field may store therein a scramble seed (explained later). The scramble seed may be stored in another field within the physical header.

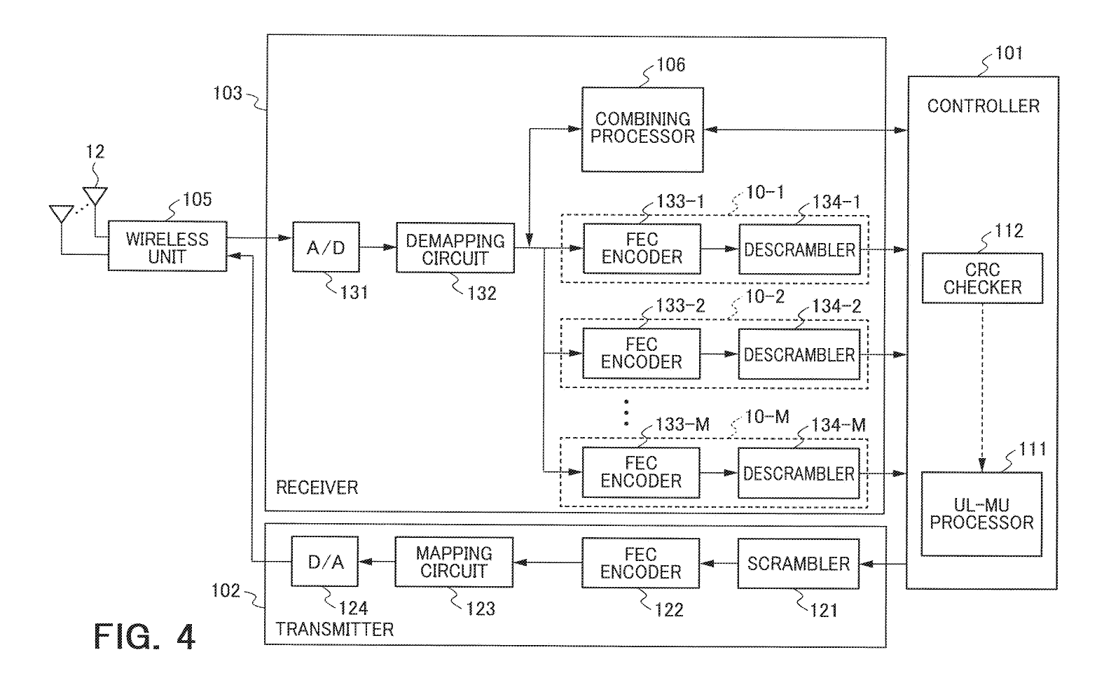

FIG. 4 is a functional block diagram of the wireless communication device installed in the access point according to an embodiment of the present invention. The wireless communication device includes a controller 101, a transmitter 102, a receiver 103, a wireless unit 105, and one or more antennas 12. In the following explanation, it is assumed that UL-OFDMA is implemented as UL-MU; however, the UL-MU-MIMO scheme is also possible.

The wireless communication device is connected to the network to which the terminals 1 to 9 belong and which is illustrated in FIG. 1. The access point may also include another wireless communication device connected to another network different from the one provided on the terminals 1 to 9 side. All or a part of the processes performed in digital domains of the controller 101, the transmitter 102, and the receiver 103 may be performed by software (a computer program) operated by a processor such as a CPU, may be performed by hardware, or may be performed by both the software and the hardware. The access point may include a processor that performs all or a part of the processes of the controller 101, the transmitter 102, and the receiver 103.

A buffer may be provided for the purpose of exchanging data or the like between the controller 101 and an upper layer. The upper layer is configured to perform a process corresponding to a protocol superordinate to the MAC layer such as TCP/IP or UDP/IP, for example. The buffer may be a volatile memory such as a DRAM or an SRAM or may be a non-volatile memory such as a NAND or an MRAM. For example, the upper layer stores data received from another network into the buffer for the purpose of relaying the data to the network provided on the terminals 1 to 9 side. Further, the controller 101 may forward data received from any of the terminals 1 to 9 to the upper layer via the buffer. Processes corresponding to TCP/IP or UDP/IP may be performed by the controller 101, while processes of an application layer superordinate thereto may be performed by the upper layer. The processes of the upper layer may be performed by software (a computer program) operated by a processor such as a CPU, may be performed by hardware, or may be performed by both the software and the hardware.

The controller 101 primarily performs processes of the MAC layer as well as all or a part of processes of the physical layer. The controller 101 includes a UL-MU processor 111 that performs a process related to UL-MU and a CRC checker 112 that performs a CRC check on a frame or a packet.

The controller 101 is configured to control communication with any of the terminals by transmitting and receiving a frame (more specifically, a packet obtained by appending a physical header to a frame; the same applies hereinafter), via the transmitter 102 and the receiver 103. Further, the controller 101 may exercise control so that a beacon frame is transmitted for the purpose of regularly providing a notification about attributes and synchronization information of the Basic Service Set (BSS) of the access point. Further, the controller 101 may include a clock generator configured to generate a clock signal, so that the time within the device is managed by using the clock signal generated by the clock generator. The controller 101 may output the clock signal generated by the clock generator to the outside. Alternatively, the controller 101 may receive an input of a clock signal generated by a clock generator provided on the outside and manage the time within the device by using the input clock signal.

In response to an association request from any of the terminals, the controller 101 performs an association process and exchanges, with each other, necessary information about capability, attributes, and the like (which may include, for example, capability information as to whether or not being compatible with UL-OFDMA), so as to establish a wireless link with the terminal. When the association process is successfully performed, the controller 101 assigns an identifier (an Association ID [AID]) used for identifying the terminal within the BSS, to the terminal. The controller 101 further transmits an association response including the AID together with information indicating that the association process was successfully performed (i.e., the Status Code field is “0”, which means a “success”). As necessary, an authentication process may be performed between the controller 101 and the terminal, prior to the association process.

The controller 101 may be configured to understand the state of a buffer 104 (e.g., whether or not there is data addressed to a terminal) by checking on the buffer 104 regularly. Alternatively, the controller 101 may check the state of the buffer 104 as being triggered from the outside. The controller 101 may organize terminals with which wireless links have been established into groups so as to manage the groups. The controller 101 may assign a group identifier (e.g., a group ID) to each of the groups and may provide the terminals belonging to the BSS with a list showing a relationship between the terminals and the groups.

The controller 101 exercises control so that a frame is transmitted (by a single-user transmission) either at the time when an access right to a wireless medium is acquired according to CSMA/CA or with predetermined timing. More specifically, the controller 101 generates the packet, which is configured with binary data, so as to have a data size conforming to the packet format. The controller 101 generates the packet by appending the physical header to the frame. In the physical header, a service field (that is 16-bit long, for example) indicated in FIG. 3(B) may be present. The controller 101 supplies the generated packet to a scrambler 121 included in the transmitter 102.

The transmitter 102 includes the scrambler (a scramble circuit) 121, an FEC encoder 122, a mapping circuit 123, and a D/A converter 124. The scrambler 121 generates a scramble code (“0” or “1”) in a predetermined pattern in synchronization with a clock signal. The scrambler 121 interchanges between “0s” and “1s” (inverts the polarities) in input data (a data string in the packet) in accordance with the generated scramble code and thereby artificially randomizes the input data. The pattern of the scramble code is periodical, and the pattern is determined according to a scramble seed (an initial value) used by the scrambler 121. In the field of wireless communication, it is a common practice to perform a scramble process on transmission data, for the purpose of smoothing the frequency spectrum (avoiding spike-shaped spectra) of a transmitted signal or for the purpose of keeping small the Peak to Average Power Ratio (PAPR: a ratio between a peak amplitude and an average amplitude) of a temporal waveform of a transmitted signal. The scramble process may be performed on the entire input data or on a part of the input data.

In an example, the scrambler 121 is configured to include: a shift register including a large number of flip-flops connected in series and a first EX-OR circuit; and a second EX-OR circuit. The shift register generates the scramble code having the periodical pattern, whereas the second EX-OR circuit converts the input data in accordance with the generated scramble code. The values of the plurality of flip-flops in an initial state in the shift register correspond to the scramble seed (the initial value). Each of the descramblers (descramble circuits) 134-1 to 134-M (explained later) also has the same configuration as that of the scrambler 121.

The configurations of the scrambler 121 and the descramblers 134 are not limited to the configuration described above. As long as the devices on the transmission side and the reception side have mutually-the-same configuration, it is possible to adopt any configuration. The scramble seed or a rule to change the scramble seed may be determined in advance. Further, another system is also acceptable in which a device provided on the transmission side inserts a scramble seed into the physical header or the service field of a packet to be transmitted, so that a device provided on the reception side takes out the scramble seed from the received packet and configures the scramble seed into the descramblers. When the device on the transmission side provides the reception side with the scramble seed, the header or the field into which the scramble seed is inserted may be in any location as long as the devices on the transmission side and the reception side have mutually-the-same recognition. By descrambling the received signal while using the same scrambler (also the same scramble seed) as used by the device on the transmission side, the device on the reception side is able to return the scrambled data to its original state.

The Forward Error Correction (FEC) encoder 122 serving as an error correction encode circuit is configured to perform an error correction encode process on an output of the scrambler 121. Examples of the error correction encode process include a convolution encode process, a turbo encode process, and a Low Density Parity Check (LDPC) encode process. The FEC encoder 122 supplies the transmission data on which the error correction encode process has been performed, to the mapping circuit 123.

The mapping circuit 123 is configured to map (modulate) “0s” and “1s” in the data supplied thereto from the FEC encoder 122 into a waveform of a transport frequency. Examples of the mapping process include Binary Phase Shift Keying (BPSK), Quadrature Phase Shift Keying (QPSK), Quadrature Amplitude Modulation (QAM), and the like, but it is acceptable to use any modulation scheme. The mapping circuit 123 supplies a modulated signal, which is a digital signal, to the D/A converter 124.

The D/A converter 124 is configured to convert the modulated signal into an analog signal and further supplies the analog signal to the wireless unit 105.

The wireless unit 105 is configured to generate a signal having a constant frequency by using a Phase Locked Loop (PLL) circuit. On the basis of the signal having the constant frequency, the wireless unit 105 up-converts the output signal (the analog signal) from the D/A converter 124 to a signal having a wireless frequency, by using a transmission-specific mixer. The wireless unit 105 amplifies the up-converted signal by using an RF amplifier and further transmits the amplified signal into the space through the antennas 12 as a radio wave. As a result, a packet having a wireless frequency is transmitted.

With respect to any of the terminals with which a wireless link has been established, the controller 101 is configured to schedule UL-MU and to control execution of UL-MU, by using the UL-MU processor 111. The controller 101 selects a plurality of terminals that perform a UL-MU transmission (assumed to be UL-OFDMA in the present example) and selects a resource to be used by each of the plurality of terminals. Further, with respect to the selected terminals, the controller 101 also determines other parameters to be used in the UL-MU transmission, such as a packet length, a transmission power, a Modulation and Coding Scheme (MCS), and the like. The packet length may be, for example, the length of a Physical Layer Convergence Protocol (PLCP) Protocol Data Unit (PPDU). The controller 101 generates a trigger frame having configured therein information designating the selected terminals, information designating the resources to be used by the terminals, and information about other parameters. The RA of the trigger frame is either a broadcast address or a multi-cast address. The TA of the trigger frame is a MAC address (i.e., the BSSID) of the access point. A detailed format of the trigger frame will be explained later. The controller 101 generates a packet by appending the physical header to the generated trigger frame and further transmits the generated packet via the transmitter 102 and the wireless unit 105. Operations of the transmitter 102 and the wireless unit 105 are the same as described above.

The signal received by the antennas 12 is input to the wireless unit 105. The wireless unit 105 amplifies the received signal with a Low Noise Amplifier (LNA). The wireless unit 105 further down-converts the amplified signal on the basis of a signal that has a constant frequency and is generated by the PLL circuit. On the basis of the down-converted signal, the wireless unit 105 extracts a signal in a desired band by using a reception-specific filter. When receiving a signal transmitted by UL-OFDMA, the wireless unit 105 extracts a signal for each of a plurality of resources used in UL-OFDMA. A filter process to extract the signal for each of the resources may be performed in an analog domain or may be performed in a digital domain.

In an example, the wireless unit 105 may be configured so as to include a selector capable of switching the connection destination of the antennas 12 between the LNA amplifier and an RF amplifier, so that the connection destination of the antennas 12 is different between the times of transmissions and the times of receptions.

The output signal, which is an analog signal, of the wireless unit 105 is input to an A/D converter 131 included in the receiver 103.

The receiver 103 includes the A/D converter 131, a demapping circuit 132, decode processors (decode systems) 10-1 to 10-M of which the total quantity is M, and a combining processor 106. The value M indicates the maximum quantity of terminals that can be multiplexed in UL-MU (the maximum multiplex number). In the present embodiment, the maximum multiplex number is equal to the quantity of the decode processors; however, these values do not necessarily need to be equal to each other. The quantity of the decode processors may be larger than the maximum multiplex number. The decode processors 10-1 to 10-M are able to operate in parallel to one another. The decode processor 10-1 includes an FEC decoder 133-1 and a descrambler 134-1. Each of the other decode processors 10-2 to 10-M also has the same configuration. In the explanation below, an arbitrary one of the decode processors will be referred to as a decode processor 10. Similarly, an arbitrary one of the FEC decoders will be referred to as an FEC decoder 133, while an arbitrary one of the descramblers will be referred to as a descrambler 134.

The A/D converter 131 is configured to convert the signal input thereto from the wireless unit 105 into a digital signal and to supply digital reception data to the demapping (demodulating) circuit 132.

The demapping circuit 132 is configured to convert the reception data into a string of pieces of likelihood information indicating the probability of being “1” or “0”. The likelihood information is soft value data including an amplitude and a sign and indicates, for example, that the probability of the reception data being “1” is 80%, while the probability of the reception data being “0” is 20%. For example, the larger amplitude value with a positive sign is in the likelihood information, the higher is the probability of the reception data being “1”. Conversely, the larger amplitude value with a negative sign is in the likelihood information, the higher is the probability of the reception data being “0”. Generally speaking, wireless communication signals are distorted due to fading factors in channels or noise from wireless devices, the demapping circuit 132 calculates the likelihood information while taking the impacts of the distortions and the noise into account. When UL-OFDMA is used, with respect to each of the resources, digital reception data is input, and the likelihood information is calculated. It should be noted that, however, when the process of extracting a band signal for each of the resources is performed in a digital domain, the band signal for each of the plurality of resources is extracted by performing a digital filter process at a stage prior to the demapping circuit 132.

In FIG. 4, the demapping circuit 132 is provided in common to the decode processors. However, another arrangement is acceptable in which M demapping circuits are provided in one-to-one correspondence with the decode processors. In that situation, when UL-OFDMA is used, for each of the resources, digital reception data may be input to a corresponding one of the demapping circuits. It is acceptable to determine, in advance, to which one of the demapping circuits, the reception data of which resource should be input. Alternatively, the controller 101 may designate the correspondence between the resources and the demapping circuits. Each of the demapping circuits calculates the likelihood information from the reception data. When a packet is transmitted by SU, it is sufficient when the reception data is input to one of the demapping circuits. It is acceptable to determine, in advance, to which one of the demapping circuits, the reception data should be input. Alternatively, the controller 101 may designate the demapping circuit to have the input.

When having received the packet transmitted by SU, the demapping circuit 132 supplies the calculated likelihood information to one of the decode processors 10-1 to 10-M. The decode processor to which the likelihood information is to be supplied may be determined in advance, may be determined by the demapping circuit 132 while using a certain criterion for determining, or may be designated to the demapping circuit 132 by the controller 101. When M demapping circuits are provided in correspondence with M decode processors, it is sufficient when the one of the demapping circuits that calculated the likelihood information supplies the likelihood information to the corresponding decode processor thereof.

In contrast, when having received packets from a plurality of terminals by UL-MU, the demapping circuit 132 supplies pieces of likelihood information of the packets received from the terminals, to the decode processors corresponding to the terminals (or the resources used by the terminals). Each of the decode processors corresponding to the terminals performs a decode process on the basis of the piece of likelihood information supplied thereto from the demapping circuit 132. Further, the demapping circuit 132 supplies one or more of the pieces of likelihood information of the packets received from the terminals that are related to a combining target field, to the combining processor 106. The combining processor 106 stores the supplied likelihood information so as to be kept in association with the terminals. When M demapping circuits are provided in correspondence with M decode processors, it is sufficient when each of the demapping circuits supplies the likelihood information of a corresponding one of the packets received from the terminals, to a corresponding one of the decode processors.

FIG. 5 illustrates an exemplary configuration of the combining processor 106. The combining processor 106 includes an input/output interface (I/F) 53, memory units 50-1 to 50-K (where K is an integer of 2 or larger; in the present example, K is an integer equal to or larger than M), and a combiner 55. The combiner 55 is capable of exchanging information with the controller 101 and is configured to obtain, from the controller 101, information indicating which terminal was allocated to which resource for the UL-MU transmission. The combiner 55 allocates a different one of the memory units 50-1 to 50-K to each of the terminals and manages the correspondence relationship between the memory units and the terminals in a buffer provided on the inside thereof. The combiner 55 provides the input/output IF 53 with a notification about the correspondence relationship between the resources and the memory units. Each of the memory units includes a memory 1 and a memory 2. Each of the memories 1 and 2 may be configured with a volatile memory such as an SRAM or a DRAM, with a non-volatile memory such as a NAND or an MRAM, or with a register circuit.

The input/output IF 53 is configured to supply the likelihood information supplied thereto from the demapping circuit 132, to a corresponding one of the memory units, on the basis of the correspondence relationship. More specifically, each of the pieces of likelihood information (which will be referred to as “LLR1”) related the packets received from the terminals is stored into the memory 1 within a corresponding one of the memory units.

In this situation, as a method for determining whether a piece of likelihood information belongs to a combining target field or not, for example, the frame body field of the MAC frame may be determined as a combining target field, while the other parts (the physical header, the service field, the MAC header, and the FCS field) may be determined as a non-combining target field. Alternatively, all or a part of the MAC header may further be added as a combining target field. In another example, a part of the physical header may be added as a combining target field. In yet another example, a part (a subfield) of a predetermined field may be determined as a combining target field. As a basic concept, when a packet is retransmitted, a field having the same contents in the initially-transmitted packet (the new packet) and the retransmitted packet can be defined as a combining target field. In the following sections, a packet that has been retransmitted or data that has been retransmitted will be referred to as a retransmitted packet or retransmitted data.

Each of the FEC decoders 133-1 to 133-M included in the decode processors 10-1 to 10-M, respectively, is configured to perform an error correction decode process on the likelihood information, by using a decode scheme corresponding to the error correction codes used by the FEC encoder 122. Each of the FEC decoders performs a decode process on the basis of the likelihood information supplied thereto from the demapping circuit 132.

The pieces of decoded data (pieces of binary data) output from the FEC decoders 133-1 to 133-M are supplied to the descramblers 134-1 to 134-M, respectively.

Each of the descramblers 134-1 to 134-M has the same configuration as that of the scrambler 121 included in the transmitter 102. The output data of the descramblers 134 (i.e., the decoded packets) is supplied to the controller 101. The packets supplied to the controller 101 may contain all the fields of the transmitted packet or may have a part (L-STF, L-LTF, and/or the like) of the physical header eliminated. The elements such as L-STF, L-LTF, and the like are used at stages prior to the demapping circuit 132 and therefore may be eliminated at any of those stages.

The CRC checker 112 included in the controller 101 is configured to determine whether there is an error in the frames by performing a CRC check on the frames included in the packets. The controller 101 exercises control so that acknowledgement responses are transmitted to the terminals, in accordance with results of the CRC checks.

In an example, when there is no error in a frame (the CRC check result indicates “OK”), the controller 101 transmits a positive acknowledgment response to the transmission side. Further, in that situation, the controller 101 stores, as necessary, the data contained in the body field of the frame into a buffer serving as an interface for the upper layer. On the contrary, when there is an error in a frame (the CRC check result indicates “not OK”), the controller 101 exercises control so that no positive response is transmitted to the terminal (a positive response scheme) or so that a negative response is transmitted to the terminal (a negative response scheme). Each of the terminals determines that the transmission failed when no positive response is received even after a predetermined time period has elapsed since the transmission of the packet or when a negative response is received within a predetermined time period since the transmission of the packet. In that situation, the terminal re-transmits the packet. Regardless of whether the positive response scheme is used or the negative response scheme is used, it is acceptable to adopt a selective-repeat scheme in which responses are collectively transmitted once regarding the results of a plurality of received frames, besides a stop-and-wait scheme in which a response is transmitted every time a frame is received.

In the above example, errors in the frames are detected; however, there is another example in which the physical header contains a CRC so that it is possible to detect an error in the physical header. In that situation, a CRC check may be performed on the basis of the CRC contained in the physical header, and control may be exercised so that, when an error is detected in the physical header, no positive response is transmitted or a negative response is transmitted. In that situation, there is no need to interpret the frame arranged to the rear of the physical header.

In the following explanations, the term “packet error” may refer to either a situation in which there is an error in the physical header or a situation in which there is an error in the frame. Further, in the following explanations, it is assumed that, as a scheme for the acknowledgment responses, the positive response scheme is used by which a positive response is transmitted when a CRC check result indicates “OK”.

When UL-MU is used, the controller 101 identifies the terminal that transmitted the packet from which a CRC error was detected, from among the plurality of packets transmitted by UL-MU from the plurality of terminals. The controller 101 has already issued a notification in advance through a trigger frame or the like as to which resource is used by which terminal in the UL-MU transmission. Further, the controller 101 has an understanding about which decode processor performs a decode process for which resource. Accordingly, by finding out which decode processor decoded the packet from which the CRC error was detected, it is possible to identify the terminal in which the CRC error occurred.

As another method for identifying the terminal that transmitted the packet from which the error was detected, for example, the terminal may be identified by using the Transmitter Address (TA) value, while assuming that the TA value stored in the Address 2 field within the MAC header of the frame from which the error was detected is correct. There is no guarantee that the TA value is correct because the CRC error was detected from the packet. However, the possibility that the CRC error may have been caused by a bit error in the Address 2 field is stochastically low, considering the bit length of the whole. This method is therefore also acceptable.

When no error is detected from the packet received at the first time, the controller 101 provides the combining processor 106 with the identifier of the terminal (or the identifier of the resource used for the first-time transmission). The combining processor 106 deletes the likelihood information of the terminal from the memory 1 of the corresponding memory unit. In this situation, the method used for deleting the likelihood information from the memory may be any method as long as it is recognizable within the combining processor that the value in the memory 1 is invalid. For example, a deletion flag corresponding to the memory may be turned on. When there is at least one terminal in which a packet error has occurred, the controller 101 provides the combining processor 106 with the identifier of the terminal (the combining target terminal).

Further, as a method for storing the likelihood information into the memory 1 within the corresponding memory unit of the combining processor 106, an arrangement is acceptable in which, only when an error is detected in a packet received at the first time, the controller 101 provides the demapping circuit 132 with a notification instructing that the likelihood information should be stored into the corresponding memory 1.

When at least one combining target terminal as described above is present among the plurality of terminals that performed the UL-MU transmission for the first time, the controller 101 selects a number of terminals of which the quantity is smaller than the maximum multiplex number M, when scheduling the next and later UL-MU transmissions (which may be referred to as the second-time UL-MU transmission). The terminals are selected so as to include at least one combining target terminal. When there are two or more combining target terminals, the controller 101 may select one combining target terminal or may select two or more combining target terminals. The controller 101 selects terminals of which the quantity is equal to or smaller than a value K (K=M−N) obtained by subtracting the quantity N of the selected combining target terminals from the maximum multiplex number M. In one example, when the maximum multiplex number M is 9, while the quantity of the selected combining target terminals is 1, the controller 101 selects eight (K=8) terminals. One of the eight terminals is the combining target terminal. When the quantity of the selected combining target terminals is 2, the controller 101 selects six terminals. Two of the six terminals are the combining target terminals.

The controller 101 generates a trigger frame designating the selected terminals (including the one or more combining target terminals). In other words, the controller 101 selects the resource to be used by each of the selected terminals and further determines other parameters to be used in the UL-MU transmission, such as a packet length, a transmission power, an MCS, and the like. After that, the controller 101 generates the trigger frame having these pieces of information configured therein. The controller 101 generates a packet by appending a physical header to the generated trigger frame and further transmits the generated packet via the transmitter 102 and the wireless unit 105. Furthermore, the controller 101 provides the combining processor 106 with a notification indicating the identifiers of the resources to be used by the selected terminals (the combining target terminals and the other terminals) and the identifiers of the terminals.

When a predetermined time period has elapsed since the completion of the transmission of the trigger frame, the plurality of terminals designated in the trigger frame each transmit a packet by a UL-MU transmission (the second-time UL-MU transmission) while using the respective designated resource. The access point receives these packets via the antennas 12 and the wireless unit 105. The demapping circuit 132 performs a demapping process on the reception signal (the digital signal) of the packet for each of the resources and generates likelihood information of the reception data of each of the packets.

The controller 101 exercises control so that, with respect to the terminals other than the combining target terminals, the demapping circuit 132 supplies the pieces of likelihood information of the packets to the corresponding decode processors 10, and in addition, among those pieces of likelihood information, pieces of likelihood information belonging to the combining target fields are also supplied to the combining processor 106. The combining processor 106 stores the pieces of likelihood information of the terminals other than the combining target terminals into the memories 1 within the memory units corresponding to the terminals. In other words, with respect to the terminals other than the combining target terminals, the combining processor 106 performs the same process as the process performed for the first-time UL-MU transmission described above.

In contrast, with respect to the one or more combining target terminals, the controller 101 exercises control so that the decode process on the packets received in the second-time UL-MU transmission are performed by using two decode processors (which will be referred to as a decode processor 10-A and a decode processor 10-B).

More specifically, the controller 101 exercises control so that the pieces of likelihood information of each of the received packets (i.e., both the likelihood information belonging to the combining target field and the likelihood information not belonging to the combining target field) are supplied to the decode processor 10-B. In other words, the decode processor 10-B performs the decode process by using the same method as the one used in the first-time UL-MU transmission.

The controller 101 exercises control so that the demapping circuit 132 supplies, from among the pieces of likelihood information of each of the received packets, the likelihood information that does not belong to the combining target field to the decode processor 10-A and so that, with respect to the combining target field, the combining processor 106 combines likelihood information and supplies the combined likelihood information. In this situation, another arrangement is also acceptable in which, when the packet is received for the first time, the likelihood information that does not belong to the combining target field is also stored into the memory 1, so that, when the packet is received for the second time, the likelihood information stored in the memory 1 is used (supplied to the decode processor 10-A) also for the non-combining target fields (the fields other than the combining target field).

The likelihood information combining process performed by the combining processor 106 will be explained. With respect to each of the combining target terminals, the combining processor 106 receives a piece of likelihood information belonging to the combining target field from the demapping circuit 132 and further stores the received piece of likelihood information into the memory 2 within the corresponding memory unit. The combiner 55 reads and combines the likelihood information LLR1 stored in the memory 1 of the same memory unit (the likelihood information of the combining target field of the packet received from the combining target terminal in the first-time (initial) UL-MU transmission) with the likelihood information LLR2 stored in the memory 2 (the likelihood information of the combining target field of the packet received from the combining target terminal in the second-time (retransmitted) UL-MU transmission) so as to obtain combined likelihood information LLR3. The combining processor 106 outputs the combined likelihood information LLR3 to the decode processor 10-A. The FEC decoder included in the decode processor 10-A performs a decode process by using the likelihood information supplied thereto from the demapping circuit 132 with respect to the fields other than the combining target field and performs a decode process by using the combined likelihood information LLR3 supplied thereto from the combining processor 106 with respect to the combining target field. It should be noted that, however, another arrangement is also acceptable in which, as explained above, when the packet is received for the first time, the likelihood information is stored into the memory 1 also for the fields other than the combining target field, so that, when the packet is received for the second time, the stored likelihood information is used for the decode process.

In an example, the combining processor 106 stores the likelihood information LLR1 belonging to the combining target field of a packet received in the first-time UL-MU transmission from the terminal 1 performed while using a certain resource, into the memory 1 of the memory unit 50-1. Further, when a CRC error is detected from the packet and while a retransmitted packet is waited for, the combining processor 106 stores the likelihood information LLR2 belonging to the combining target field of a packet received in the second-time UL-MU transmission while using the same resource or a different resource, into the memory 2 of the memory unit 50-1. After that, the combining processor 106 combines together the pieces of likelihood information stored in the memory 1 and the memory 2, so as to obtain combined likelihood information. The combining processor 106 then supplies the combined likelihood information to the decode processor 10-A. When the terminal 1 performs the reception by using a different resource from the one used at the first time, a notification is received in advance indicating that a change has occurred in the correspondence relationship between the resources and the terminals.

There are various methods that can be used for combining the pieces of likelihood information. As one example, there is a method by which a weighted sum (a linear combination) is calculated from the two pieces of likelihood information. The weights (coefficients) to be applied to the pieces of likelihood information may be determined by using a predetermined method. An example of a formula to combine the pieces of likelihood information is shown below.

LLR3(k)=C1(k)×LLR1(k)+C2(k)×LLR2(k) [Formula 1]

where k is an integer equal to or larger than 1 and equal to or smaller than N; N is the data length of the binary data observed after the error correction encode process is performed; C1(k) and C2(k) are each a weight; LLR3(k) is the combined likelihood information.

In this manner, by combining the likelihood information of the packet received at the first time (the new packet) with the likelihood information of the retransmitted packet, it is possible to improve the level of precision of the decode process. With this arrangement, it is possible to eliminate the CRC errors while reducing the number of times the packets are retransmitted. The amplitude of the likelihood information includes a distortion component compared to the original amplitude, due to the noise and channel characteristics. The distortions includes random distortions caused by thermal noise in the device used on the reception side and impacts from characteristics of the channel. The random distortions are reduced by half (lowered by 3 dB) when going through an addition. For this reason, by adding the pieces of likelihood information together, it is possible to obtain the correct piece of likelihood information by eliminating the impacts of the noise. Further, it is also acceptable to set an upper limit value to the number of times the packet can be retransmitted. In that situation, when the number of times the packet is retransmitted has reached the upper limit value, the information stored in the corresponding memory unit (the memory 1 and the memory 2) of the combining processor 106 may be deleted.

With respect to each of the combining target terminals, the controller 101 receives a decoded packet from each of the decode processors 10-A and 10-B. The packet received from the decode processor 10-A is a packet obtained through a decode process that uses the combined likelihood information and will be referred to as a “packet A”. The packet received from the decode processor 10-B is a packet obtained through a decode process that uses only the likelihood information of the packet received at this time, without using the combined likelihood information and will tentatively be referred to as a “packet B”. The controller 101 performs a CRC check on the packet A and the packet B.

With respect to each of the combining target terminals, the controller 101 exercises control so that a positive response is returned when one of the check results of the packet A and the packet B is “OK”. When a frame used as an acknowledgment response has no field to store therein a sequence number, it is considered that, when the sender terminal receives a positive response, the terminal regards the positive response as a positive response for the frame transmitted immediately prior. When the frame has a field to store therein a sequence number, it is possible to provide the terminal being the origin of transmission with a notification explicitly indicating for which frame the positive response was sent, by storing the sequence number therein.

Further, the controller 101 determines whether the packet received from each of the combining target terminals at this time is a retransmitted packet or a new packet. There are various methods that can be used for making the determination. As an example, a method will be explained by which a combination of results of CRC check performed on the packet A and the packet B is used.

When the check results of both the packet A and the packet B are “OK”, the packet received at this time is considered to be a retransmitted packet.

When the CRC check result of the packet A is “OK”, while the CRC check result of the packet B is “not OK”, the packet received at this time is also considered to be a retransmitted packet.

When the CRC check result of the packet A is “not OK”, while the CRC check result of the packet B is “OK”, there are two possibilities that the packet received at this time may be a new packet or may be a retransmitted packet. To cope with this situation, in an example, it is acceptable to check the retry bit in the MAC header of the packet B so as to determine that the packet is a retransmitted packet when the retry bit is 1 and so as to determine that the packet is a new packet when the retry bit is 0.

When the check results of both the packet A and the packet B are “not OK”, there are two possibilities that the packet received at this time may be a retransmitted packet or may be a new packet. In one example, it is acceptable to check the retry bits in the MAC headers of the packet A and the packet B so as to determine whether the packet is a retransmitted packet or a new packet on the assumption that, when the two retry bits have the same value as one another, the value is correct. Another method is also acceptable in which, instead of with the packet A, the packet B is compared with a packet stored in the memory 1 within the corresponding memory unit of the combining processor 106 prior to the likelihood information combining process (in which situation, the likelihood information of the non-combining target fields is also stored in the memory 1 in advance).

Alternatively, it is also acceptable to check, instead of the values of the retry bits, the sequence number appended to the inside of the MAC header, so as to determine that the packet is a retransmitted packet when the sequence numbers of the two packets are the same as each other. There is no guarantee that the values of the sequence numbers are correct because both the packet A and the packet B are each a packet from which a CRC error was detected. However, the possibility that the CRC error may have been caused by a bit error in the sequence number field is stochastically low, considering the bit length of the whole. This method is therefore also acceptable. Alternatively, it is also acceptable to make a determination by combining the values in the retry bit field and the sequence number field.

Alternatively, it is also acceptable to determine whether the packet is a retransmitted packet or a new packet, by using a level of similarity between pieces of likelihood information, as explained later.

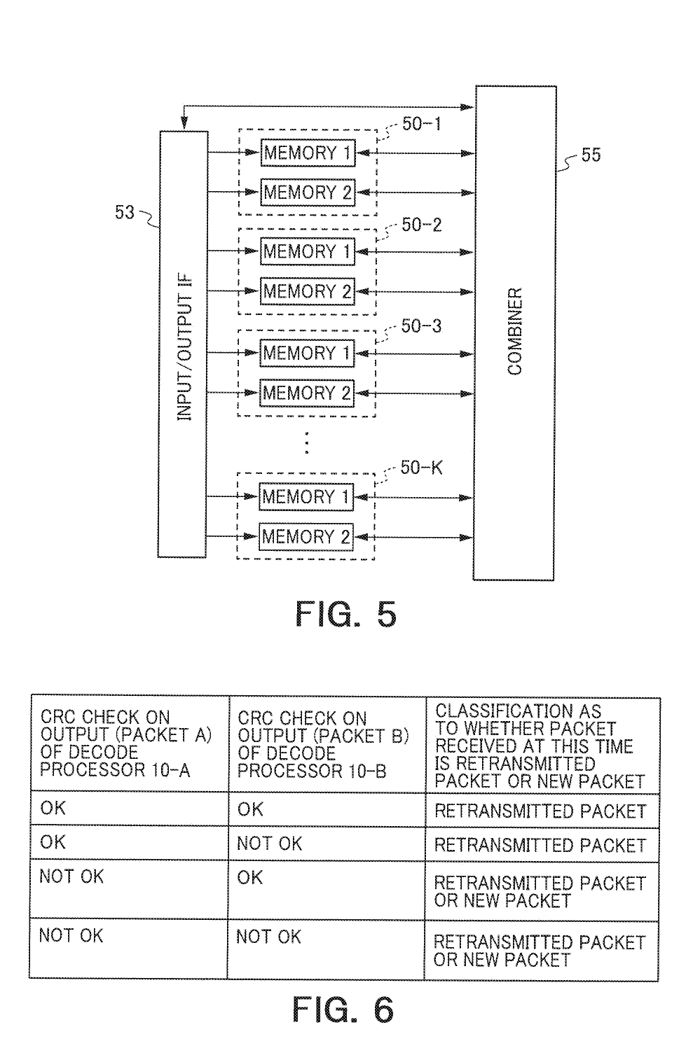

FIG. 6 illustrates a table that summarizes CRC check results of the packets A and B and the classifications as to whether the packet is a retransmitted packet or a new packet.

When the retransmitted packet is received successfully, the controller 101 instructs the combining processor 106 to delete all of the likelihood information related to each of the combining target terminals, from the corresponding memory unit. In response to the instruction, the combining processor 106 deletes the contents of the memory 1 and the memory 2 within the corresponding memory unit. Further, when it is determined that a new packet has been received, and the CRC check indicates “OK”, it is determined that there is a possibility that a retransmitted packet may be transmitted again in the future and the likelihood information stored in the memory 1 of the corresponding memory unit is kept, while the contents of the memory 2 are erased. In contrast, when it is determined that a retransmitted packet was transmitted but fails to be received, the memory 1 in the corresponding memory unit is overwritten with the combined likelihood information (In the third-time UL-MU transmission, the likelihood information after the overwrite process is treated as the likelihood information LLR1 described above), and the memory 2 is erased. Alternatively, it is also acceptable to keep the contents of the memory 1, while discarding the combined likelihood information.

In Formula 1 used for combining the pieces of likelihood information presented above, it is also acceptable to change the weights in accordance with the number of times the packet is retransmitted. For example, an arrangement is acceptable in which the larger the number of times the packet is retransmitted, the larger is the weight applied to the likelihood information LLR1 (the combined value of pieces of likelihood information corresponding to as many times as “the number of times the packet is retransmitted−1”), and the smaller is the weight applied to the likelihood information LLR2. For example, Formula 2 related to the weights may be defined as shown below, where R denotes the number of times the packet is retransmitted. When the packet is retransmitted for the first time, R=1 is satisfied. In this situation, when the packet is retransmitted two times or more, the combined likelihood information calculated immediately prior may be stored in the memory 1, as mentioned above.

C1(k)=1/(R+1)

C2(k)=R/(R+1) [Formula 2]

With respect to the terminals other than the combining target terminals, a decoded packet is received from a corresponding one of the decode processors, and a CRC check is performed. To each of the terminals of which the CRC check results are “OK”, an acknowledgment response is transmitted. When there are one or more terminals of which the CRC check results are “not OK”, these terminals are newly treated as combining target terminals when scheduling the next UL-MU transmission. Any of the combining target terminals that was unable to receive the retransmitted packet in the second-time UL-MU transmission (a terminal that received a new packet instead of the retransmitted packet or a terminal that, although the retransmitted packet was transmitted thereto, failed to receive the retransmitted packet) will continuously be treated as a combining target terminal when scheduling the next UL-MU transmission.

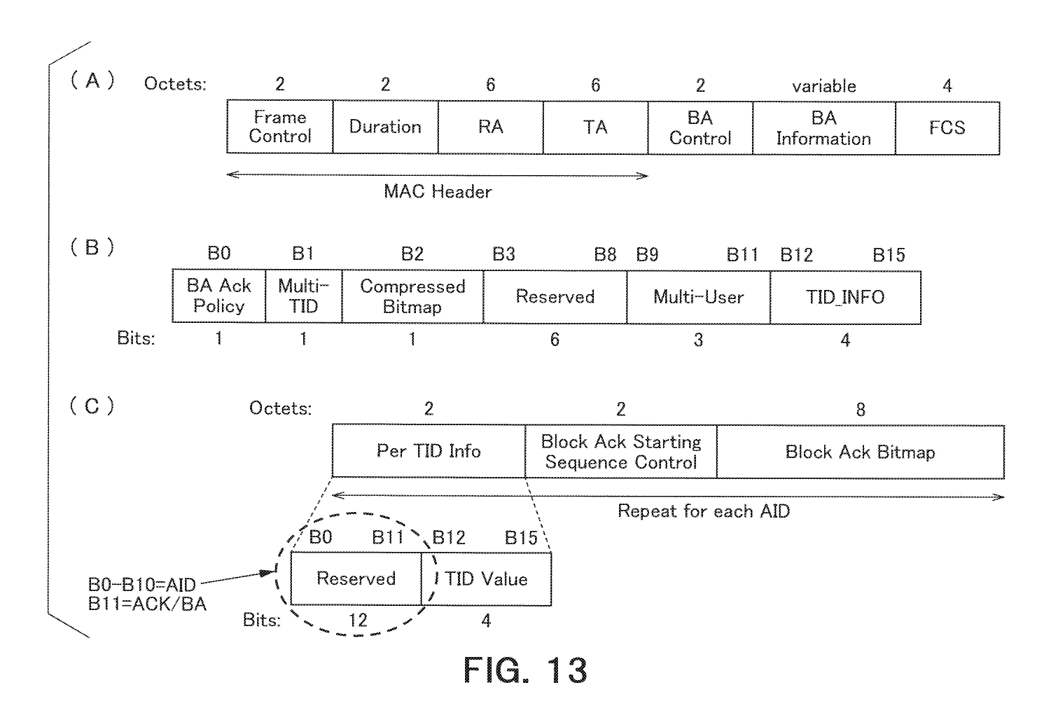

As for the transmissions of the acknowledgment responses to the combining target terminals and the other terminals, acknowledgment frames may sequentially be transmitted to the individual terminals, or the acknowledgment frames may simultaneously be transmitted to the terminals in a multiplexed manner, i.e., by a DownLink Multi-User transmission. Alternatively, it is also acceptable to generate one frame that collectively contains the acknowledgments for the terminals and to transmit the generated frame. As an example of such a frame, a frame called a Multi-STA BA frame (see FIG. 13 explained later) obtained by expanding a BA frame is discussed by an IEEE 802.11ax committee. It is also acceptable to use the Multi-STA BA frame.

In a situation where the access point performed single-user communication with a terminal, when an error is detected in a CRC check performed on a packet received from the terminal, the access point may treat the terminal as a combining target terminal when scheduling the next and later UL-MU transmissions so as to perform a decode process that uses the likelihood information combining process. When receiving a packet transmitted by single-user communication, the controller 101 may designate a decode processor to be used in the decode process to the demapping circuit 132 and may designate a memory unit to be used, to the combining processor 106. Alternatively, the combining processor 106 may determine the memory unit to be used. Into the memory 1 of the memory unit, the likelihood information of the combining target field in the packet received by the single-user communication will be stored. After an error is detected in the CRC check performed on the packet, the same operation as described above is performed while treating the terminal as a combining target terminal. When no error is detected in the CRC check performed on the packet, it is appropriate to delete the likelihood information from the memory 1 of the memory unit. As for the method for identifying the identifier of the terminal with which the error was detected, for example, the TA stored in the Address 2 field on the inside of the MAC header may be used, as explained above. In that situation, when the TA is the MAC address that is not recognized by the controller 101 (the MAC address of a terminal that has not performed the association process with the access point), there is a high possibility that a cause of the CRC error can be derived from the Address 2 field. Accordingly, in that situation, it is acceptable to give up on identifying the terminal. In that situation, the controller 101 may delete the likelihood information of the packet from the memory 1 of the corresponding memory unit.

Further, the controller 101 may access and read from a storage storing therein the information to be provided for the terminals through trigger frames or the like, the information provided by the terminals, or both of these types of information. The storage may be an internal memory or an external memory. Also, the storage may be a volatile memory or a non-volatile memory. Further, instead of being configured with a memory, the storage may be configured with an SSD, a hard disk, or the like.

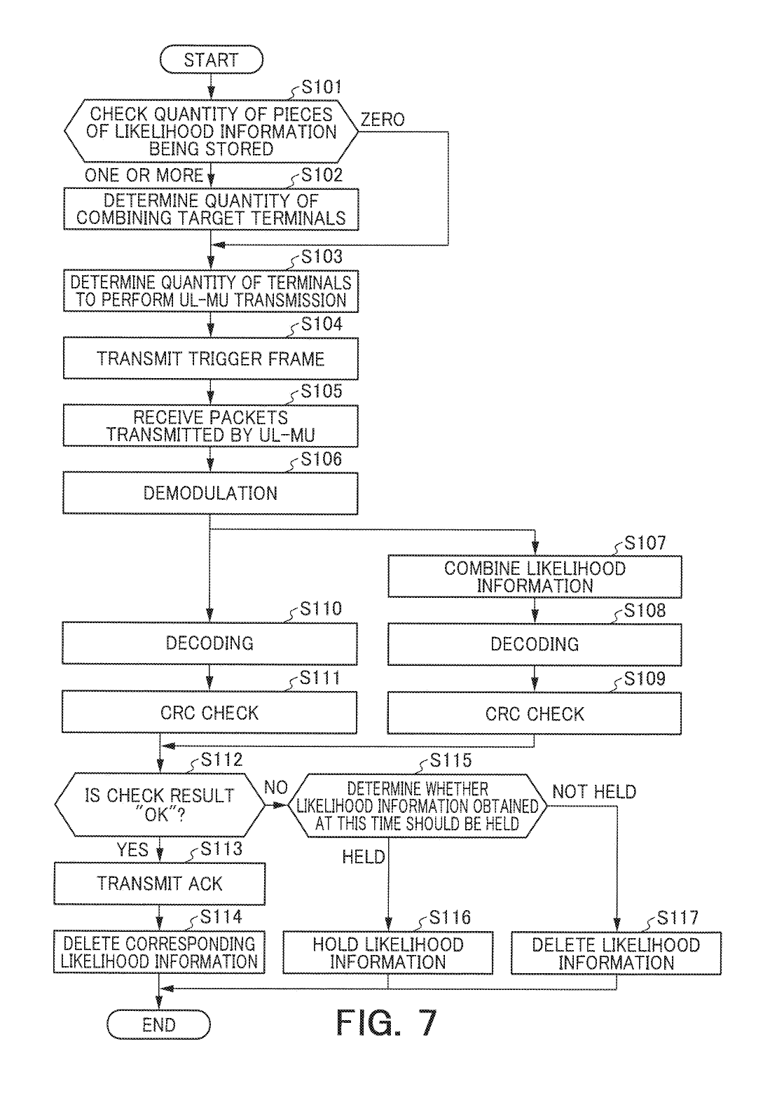

FIG. 7 is a flowchart illustrating an operation performed by the access point according to the present embodiment. The controller 101 checks the quantity of pieces of likelihood information stored in the combining processor 106 (the quantity of memory units in which likelihood information is stored in the memory 1) (S101). The memory 1 stores therein the likelihood information (which may be combined likelihood information) of such a terminal that had a CRC check result indicated as “not OK” and that has not been successful in transmitting a retransmitted packet.

On the basis of the quantity of pieces of likelihood information being stored, the controller 101 determines the quantity N of combining target terminals to be designated in the UL-MU transmission (which is assumed to be a UL-OFDMA transmission) performed at this time (S102). Because two decode processors are used for every combining target terminal, the maximum value of N is equal to the quotient obtained by dividing the maximum multiplex number M of the UL-MU transmission by 2.

The controller 101 determines the quantity of terminals to perform the UL-MU transmission and selects as many terminals as determined (S103). In that situation, the controller 101 selects at least the combining target terminals determined at step S102. The maximum value of the quantity of selected terminals is equal to “the maximum multiplex number M−the quantity of combining target terminals N”. Further, the maximum value of the quantity of terminals that are selectable besides the combining target terminals is equal to M−2×N. In these expressions, the symbol “−” denotes a subtraction, whereas the symbol “×” denotes a multiplication.

Further, with respect to the plurality of selected terminals (i.e., the combining target terminals and the other selected terminals), the controller 101 determines parameters such as resources to be used, the packet length, the transmission power, the MCS, and the like. The controller 101 generates a trigger frame that has these pieces of information configured therein. The controller 101 transmits the generated trigger frame (more specifically, a packet obtained by appending a physical header to the trigger frame) via the transmitter 102 and the wireless unit 105 (S104).

When a predetermined time period has elapsed since the completion of the transmission of the trigger frame, a plurality of packets are transmitted by a UL-MU transmission from the plurality of terminals designated in the trigger frame. These packets are transmitted by using the resources designated for these terminals. The receiver 103 included in the access point receives these packets via the wireless unit 105 (S105). The A/D converter 131 included in the receiver 103 converts the reception signals of the packets into digital signals and supplies the digital reception data to the demapping circuit 132. The demapping circuit 132 receives the reception data of the packets from the A/D converter 131. The demapping circuit 132 receives the reception data of the packets so as to be kept in association with the resources with which the packets were transmitted. An arrangement is acceptable in which a plurality of A/D converters 131 are each kept in correspondence with the individual resources in a hardware manner. Alternatively, pieces of identification information of the resources may be supplied to the demapping circuit 132 while being kept in association with the packets.

The demapping circuit 132 demodulates (demaps) the reception data of the packets and calculates the likelihood information of the reception data of each of the packets (S106). For example, the demapping circuit 132 performs the demapping process in units of symbols. Depending on the modulation scheme being used, either one bit or two or more bits correspond to each symbol, so that likelihood information is calculated for the corresponding one or more bits.

The controller 101 exercises control so that, with respect to each of the combining target terminals among the terminals designated in the trigger frame, the packet received in the UL-MU transmission is decoded by using the two decode processors (which will be referred to as the decode processor 10-A and the decode processor 10-B) (S107 through S109, and S110 and S111).

More specifically, the decode processor 10-A receives the likelihood information that does not belong to the combining target field, from the demapping circuit 132. In this situation, another arrangement is also acceptable in which, when the packet is received for the first time, the likelihood information that does not belong to the combining target field is also stored into the memory 1, so that, when the packet is received for the second time, the likelihood information stored in the memory 1 is used (supplied to the decode processor 10-A) also for the non-combining target fields (the fields other than the combining target field). With respect to the combining target field, the likelihood information that belongs to the combining target field and is calculated by the demapping circuit 132 is stored into the memory 2 within the corresponding memory unit of the combining processor 106, so that the likelihood information stored in the memory 2 is combined with the likelihood information stored in the memory 1 within the memory unit (S107), so as to calculate combined likelihood information. The calculated combined likelihood information is supplied to the decode processor 10-A. The decode processor 10-A decodes, by using the FEC decoder, the likelihood information that was supplied thereto from the demapping circuit 132 and that does not belong to the combining target field as well as the combined likelihood information that was supplied thereto from the combining processor and that belongs to the combining target field and further descrambles the decoded data by using the descrambler 134 (S108). As a result, a decoded packet (the packet A) is obtained. The controller 101 performs a CRC check on the packet A (S109).

In contrast, regardless of whether each of the pieces of likelihood information belongs to a combining target field or not, the decode processor 10-B receives all the pieces of likelihood information calculated by the demapping circuit 132, decodes the received pieces of likelihood information by using the FEC decoder, and descrambles the decoded data by using the descrambler 134 (S110). As a result, a decoded packet (the packet B) is obtained. The controller 101 performs a CRC check on the packet B (S111).

With respect to the terminals other than the combining target terminals, all of the pieces of likelihood information calculated by the demapping circuit 132 are supplied to the corresponding decode processors. Each of the decode processors decodes, by using the FEC decoder, the likelihood information supplied thereto from the demapping circuit 132 and further descrambles the decoded data by using the descrambler 134 (S110). As a result, a decoded packet is obtained. Further, among the pieces of likelihood information calculated by the demapping circuit 132, pieces of likelihood information belonging to the combining target fields are supplied to the combining processor 106 so as to be stored into the memories 1 within the corresponding memory units. The controller 101 performs a CRC check on the packets (S111).

With respect to each of the combining target terminals, when the CRC check result of one of the packets decoded by the two decode processors 10-A and 10-B is “OK” (S112: Yes), the controller 101 transmits an acknowledgment response (a positive response) (S113). When the packet of which the CRC check result was “OK” is a retransmitted packet, the combined likelihood information calculated at step S107, as well as the likelihood information stored in the memory 2 within the corresponding memory unit (the likelihood information that belongs to the combining target field of the packet received at this time), and the likelihood information stored in the memory 1 are unnecessary. Accordingly, the controller 101 deletes these pieces of likelihood information (S114).

On the contrary, when the packet of which the CRC check result was “OK” is not a retransmitted packet, but is a new packet, the likelihood information calculated at step S107 and the likelihood information stored in the memory 2 of the corresponding memory unit (the likelihood information that belongs to the combining target field of the packet received at this time) are deleted, but the likelihood information stored in the memory 1 of the corresponding memory unit is continuously held as it has been.

With respect to each of the combining target terminals, when the CRC check results of both of the packets decoded by the two decode processors 10-A and 10-B are “not OK” (step S112: No), the likelihood information stored in the memory 2 within the corresponding memory unit (the likelihood information that belongs to the combining target field of the packet received at this time) and the combined likelihood information calculated at step S107 are deleted (“NOT HELD” at S115; and S117), and control is exercised so as to continuously hold only the likelihood information stored in the memory 1.

It should be noted that, however, even when the CRC check results of both of the packets are “not OK”, when it is possible to determine whether the packet received at this time is a retransmitted packet or not, the following operation may be performed: When the packet is determined not to be a retransmitted packet, control is exercised so that the likelihood information stored in the memory 2 of the corresponding memory unit (the likelihood information that belongs to the combining target field of the packet received at this time) and the combined likelihood information calculated at step S107 are deleted (S117) and so that the likelihood information stored in the memory 1 is continuously held, in the same manner as described above. On the contrary, when the packet is determined to be a retransmitted packet, control is exercised so that the likelihood information stored in the memory 1 of the corresponding memory unit and the likelihood information stored in the memory 2 of the corresponding memory unit (the likelihood information that belongs to the combining target field of the packet received at this time) are deleted and so that the combined likelihood information calculated at step S107 is stored into the memory 1 and held (S116).

As for the operations performed by each of the terminals other than the combining target terminals, when the CRC check result of the packet is “OK” (S112: Yes), an acknowledgment response (a positive response) is transmitted (S113). Because the likelihood information that belongs to the combining target field of the packet received at this time is unnecessary, the likelihood information is deleted from the memory 1 of the corresponding memory unit (S114). On the contrary, when the CRC check result of the received packet is “not OK” (S112: No), control is exercised so that the likelihood information that belongs to the combining target field of the packet received at this time (and that is stored in the memory 1 of the corresponding memory unit) is held (“HELD” at S115; and S116).

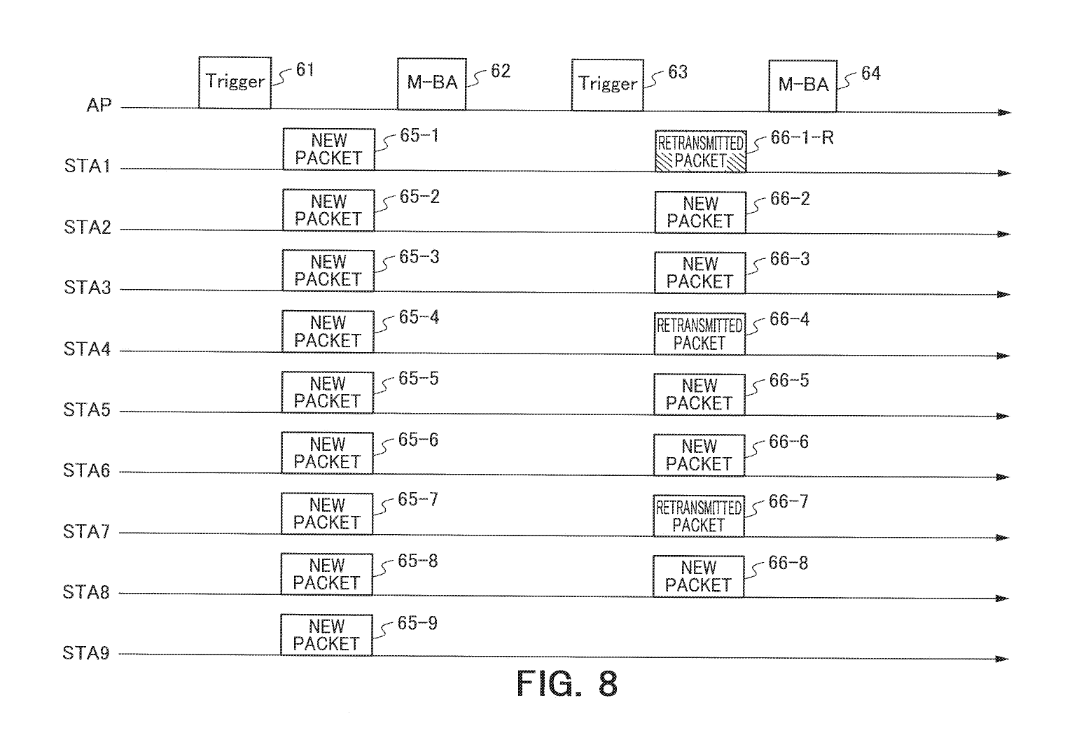

FIG. 8 illustrates an example of a sequence in a wireless communication system according to the present embodiment. The access point (indicated as “AP” in the drawing) transmits a trigger frame 61 containing information designating nine terminals 1 to 9 (STA 1 to STA 9 in the drawing) on the basis of access rights to wireless media that were acquired according to CSMA/CA. It is assumed that the maximum possible multiplex number (the quantity of decode processors) M is 9. When a predetermined time period has elapsed since the completion of the reception of the trigger frame 61, the terminals 1 to 9 transmit packets (new packets) 65-1, 65-2, 65-3, 65-4, 65-5, 65-6, 65-7, 65-8, and 65-9 by a UL-MU transmission. The predetermined time period may be an SIFS time period or may be a time period longer than the SIFS time period.

The access point receives the packets from the terminals 1 to 9 and decodes the received packets. Each of the decode processes is performed by a corresponding one of the nine decode processors, by using the likelihood information of a different one of the packets received from the terminals 1 to 9 at this time. Further, from among the pieces of likelihood information of the packets received from the terminals 1 to 9, the access point stores the pieces of likelihood information that belongs to the combining target field into the memories 1 of the corresponding memory unit within the combining processor 106. The access point performs a CRC check on the packets received from the terminals 1 to 9. An example is assumed in which it is determined that the CRC check performed on the packet received from the terminal 1 is “not OK” and that the CRC checks performed on the packets received from the terminals 2 to 9 are each “OK”. With respect to the terminals 2 to 9, the pieces of likelihood information stored as described above are deleted from the memories 1 of the corresponding memory units.

When a predetermined time period (e.g., a SIFS time period) has elapsed since the completion of the reception of the packets received from the terminals 1 to 9, the access point transmits an M-BA frame 62 collectively containing the results of the CRC checks performed for the terminals 1 to 9. Having received the M-BA frame 62, each of the terminals 1 to 9 checks the acknowledgment information addressed thereto contained in the M-BA frame 62, and the terminal 1 determines that the transmission failed, whereas the terminals 2 to 9 each determine that the transmission was successful. The access point then treats the terminal 1 as a combining target terminal. Alternatively, instead of the M-BA frame, it is also acceptable to simultaneously transmit ACK frames addressed to the terminals by a DL-MU transmission. In another example, it is also acceptable to sequentially transmit ACK frames addressed to the terminals within a predetermined time period (e.g., the SIFS time period).

Further, because the CRC check of the terminal 1 was “not OK”, the access point selects terminals of which the quantity is equal to N, which is smaller than the maximum multiplex number M, as the scheduling of the next UL-MU transmission. In the present example, it is assumed that the access point selects eight terminals (i.e., the terminals 1 to 8). The access point transmits a trigger frame 63 containing information designating the terminals 1 to 8. The trigger frame 63 may be transmitted on the basis of access rights acquired according to CSMA/CA. When a burst transmission is performed, it is also possible to transmit the trigger frame 63 without performing the carrier sense process, when a predetermined time period (e.g., a PIFS or SIFS time period) has elapsed since the completion of the transmission of the M-BA frame 62.

Further, the M-BA frame 62 and the trigger frame 63 may be transmitted as an aggregation frame (explained later) by a frame aggregation function. Alternatively, when the transmission destinations of the M-BA frame 62 and the trigger frame 63 are different from each other, the frames may be transmitted by a DL-MU transmission.

When a predetermined time period has elapsed since the completion of the reception of the trigger frame 63, the terminals 1 to 8 transmit packets 65-1-R, 66-2, 66-3, 66-4, 66-5, 66-6, 66-7, and 66-8 by a UL-MU transmission. The packet 65-1-R transmitted by the terminal 1 is a retransmitted packet for the packet that failed to be transmitted. The packets 66-2, 66-3, 66-4, 66-5, 66-6, 66-7, and 66-8 transmitted by the terminals 2 to 8 are new packets.

In this situation, the terminals other than the terminal STA 1 designated in the trigger frame 63 may be terminals different from the terminals STA 2 to STA 9 designated in the trigger frame 61.

The access point receives the packets transmitted from the terminals 1 to 8 by the UL-MU transmission and further decodes the received packets. With respect to the terminal 1, the access point performs the decode process by using the two decode processors (10-A and 10-B). With respect to each of the terminals 2 to 8, the access point performs the decode process by using a different one of the remaining seven decode processors.

More specifically, with respect to each of the terminals 2 to 8, the access point performs the decode process by using the likelihood information of the packet received at this time, while using the corresponding decode processor. Among the pieces of likelihood information of the packets received from the terminals 2 to 8, the pieces of likelihood information that belong to the combining target fields are stored into the memories 1 of the corresponding memory units.

In contrast, with respect to the terminal 1, the likelihood information related to the combining target field is stored into the memory 2 of the corresponding memory unit. Further, combined likelihood information is generated by combining together the pieces of likelihood information stored in the memory 1 and the memory 2 of the corresponding memory unit. In the one of the decode processors (i.e., 10-A), the decode process is performed by using the combined likelihood information with respect to the combining target field and by using the likelihood information of the packet received at this time with respect to the non-combining target fields. In the other decode processor (i.e., 10-B), the decode process is performed by using the likelihood information of the packet received at this time (both the likelihood information that belongs to the combining target field and the likelihood information that does not belong to the combining target field).

With respect to the terminals 1 to 8, the access point checks for errors in the decoded packets. With respect to the terminal 1, the access point receives the decoded packets from the two decode processors 10-A and 10-B and performs a CRC check on each of the packets. In the present example, a situation is assumed in which it is determined that the result of the CRC check performed on at least the packet received from the decode processor 10-A is “OK”, while the CRC checks performed on the packets received from the terminals 2 to 8 are all “OK”. When a predetermined time period (e.g., an SIFS time period) has elapsed since the completion of the reception of the packets transmitted by the UL-MU transmission, the access point transmits an M-BA frame 64 collectively containing the result of the CRC checks for the terminals 1 to 8. The access point determines that the packet received from the terminal 1 at this time is a retransmitted packet and therefore deletes the pieces of likelihood information stored in the memory 1 and the memory 2 within the memory unit, with respect to the terminal 1. With respect to the terminals 2 to 8, the access point also deletes the likelihood information stored in the memories 1 within the corresponding memory units.

In the embodiments described above, the UL-MU transmission was assumed to be an UL-OFDMA transmission; however, it is possible to similarly carry out the present disclosure even when the UL-MU transmission is a UL-MU-MIMO transmission. When a UL-MU-MIMO transmission is used, the preamble signals (the resources) contained in the packets transmitted by a plurality of terminals are used for separating the signals simultaneously received from the plurality of terminals in mutually-the-same frequency band, as streams each of which corresponds to a different one of the terminals. Subsequently, the demapping circuit 132 demaps the streams corresponding the terminals. As for the other processes, it is possible to perform basically the same operations, by replacing the resources used in the UL-FDMA transmission described in the above explanations, with the preamble signals or the streams. When the UL-OFDMA & MU-MIMO scheme is used, it is possible to similarly carry out the disclosure by considering a set made up of a resource and a preamble signal as the resource.

### First Modification Example

In the embodiment described above, when the packet received from any of the combining target terminals is determined to be a new packet while the CRC check result indicates “not OK”, it is acceptable to store the likelihood information that belongs to the combining target field among the pieces of likelihood information of the new packet, into a memory 1 of another memory unit that is prepared separately. With this arrangement, when a retransmitted packet of the new packet is transmitted in the next or later UL-MU transmission, it is possible to combine likelihood information even with respect to the new packet. As for a specific operation, the likelihood information of the received packet is stored from the demapping circuit 132 into the memory 1 of the prepared memory unit. Further, when the controller 101 determines the packet to be a new packet while the CRC check indicates “not OK”, the contents of the memory 1 are kept. On the contrary, when the controller 101 determines the packet to be a new packet, while the CRC check indicates “OK”, or when the controller 101 determines the packet to be a retransmitted packet of another packet, the contents of the memory 1 may be deleted.

### Second Modification Example

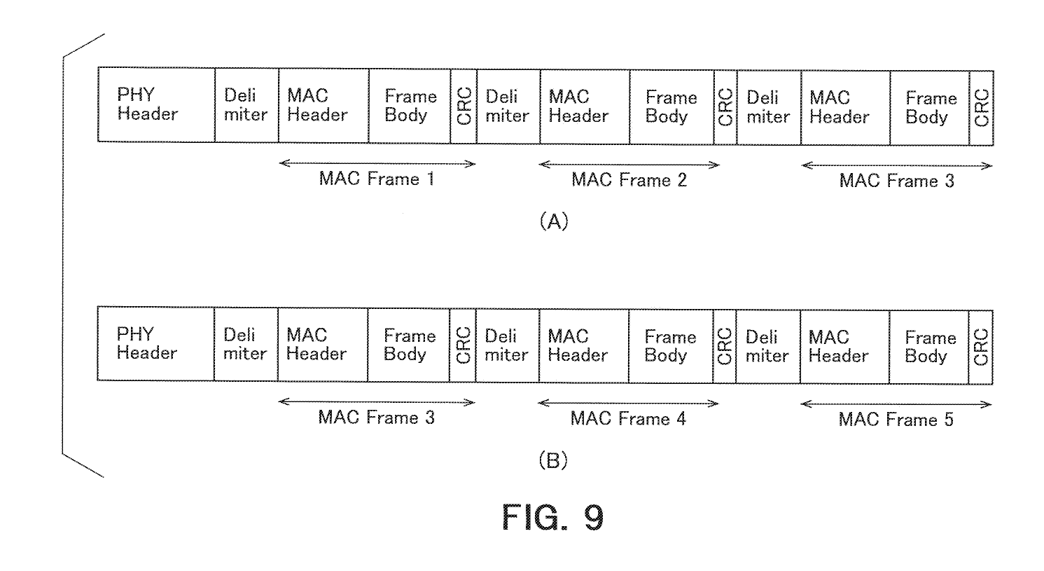

In the embodiments described above, it is assumed that each of the packets transmitted from the terminals contains one frame. However, the present disclosure is also applicable to a situation where each of the packets contains an aggregation frame in which a plurality of frames are joined together. An example of the aggregation frame is illustrated in FIG. 9(A). The packet contains a physical header and an aggregation frame. The aggregation frame includes three MAC frames 1 to 3 and delimiter each of which is appended to the head of a different one of the MAC frames. An example is assumed in which, in a packet received in a first-time transmission, the CRC checks performed on the MAC frames 1 and 2 are “OK” (the reception was successful), while the CRC check performed on the MAC frame 3 is “not OK” (the reception failed), the controller 101 transmits an acknowledgment response (e.g., a Block Ack (BA) frame) storing therein these check results. Alternatively, as explained above, it is also acceptable to use an M-STA BA frame containing the acknowledgments of all the terminals that perform the UL-MU transmission. The terminal that transmitted the packet illustrated in FIG. 9(A) receives the acknowledgment response and, in the next UL-MU transmission, transmits a packet obtained by appending a physical header to an aggregation frame containing the MAC frame 3 and MAC frames 4 and 5, as illustrated in FIG. 9(B). In this situation, the retransmitted frames are arranged on the head side of the MAC frames that are aggregated.

When the controller 101 has determined that the MAC frame 3 failed to be received and the MAC frames 1 and 2 were received successfully, the controller 101 holds only the likelihood information belonging to the combining target field of the MAC frame 3, among the pieces of likelihood information of the combining target fields stored in the memory 1 of the corresponding memory unit in the combining processor 106. The controller 101 deletes the likelihood information belonging to the combining target fields of the MAC frames 1 and 2. In this situation, by using the delimiters or the like, the controller 101 is capable of estimating the frame length of each of the MAC frames and the length of the combining target field in each of the MAC frames. On the basis of this capability, the controller 101 is able to identify only the likelihood information belonging to the combining target field of the MAC frame 3 from among the pieces of likelihood information belonging to the combining target fields that have been stored. When the packet illustrated in FIG. 9(B) is received, only the likelihood information belonging to the combining target field of the MAC frame 3 that was retransmitted is combined with the stored likelihood information described above. In this situation, as for the frame length of the retransmitted MAC frame 3 and the length of the combining target field, the values estimated at the time of the first-time transmission are used. On the basis of this arrangement, it is possible to identify the likelihood information belonging to the combining target field of the retransmitted MAC frame 3, from among the pieces of likelihood information of the packet. It is possible to perform the process in a similar manner also in the situation where a plurality of MAC frames among the aggregation frame fail to be received.

### Third Modification Example

The embodiments described above are based on the premise that, as the hybrid Automatic Repeat Request (ARQ) scheme, the scheme is used by which the likelihood information from the previous transmission is combined with the likelihood information at the time of the re-transmission process, so as to decode the combined likelihood information; however, it is also possible to use other schemes. For example, another arrangement is acceptable in which, after a packet to be transmitted is encoded, parity bits are thinned out (punctured) according to a predetermined rule, so as to generate and store one or more pieces of encoded data from the thinned-out parity bits. In the transmission performed at the first time, encoded data of the packet resulting from the thinning-out process is transmitted. When the packet is retransmitted, one of the pieces of encoded data that are stored is transmitted. Every time the packet is retransmitted, a different one of the pieces of encoded data that are stored is transmitted. Combined data is generated by combining (joining) the data obtained by demapping the encoded data received at the first time with the data obtained by demapping the encoded data received at each re-transmission process, so as to perform a decode process by using the combined data. In this situation, the combining process may be performed by using the data that was available prior to the demapping process.

Further, instead of combining the pieces of likelihood information as described above, it is also acceptable to use another scheme by which a combining process is performed by using an amplitude and phase data (corresponding to an example of the data according to the present embodiment) that were available prior to the demapping process. For example, it is acceptable to perform a Maximal Ratio Combining (MRC) process. Similarly to the embodiments described above, the combining process may be performed on the signals in the combining target fields. By using the combined data obtained in this manner, the demapping process and the decode process are performed.

### Fourth Modification Example

In the embodiments described above, it is determined whether or not the packet received from each of the combining target terminals at the second-time UL-MU transmission is a retransmitted packet, on the basis of the CRC check, the MAC header, or the physical header. In other words, the determination is made after the packet is decoded. In another example of the present embodiment, it is also acceptable to determine whether or not the packet is a retransmitted packet before combining the likelihood information, so as to perform the likelihood information combining process only when the packet is determined to be a retransmitted packet.

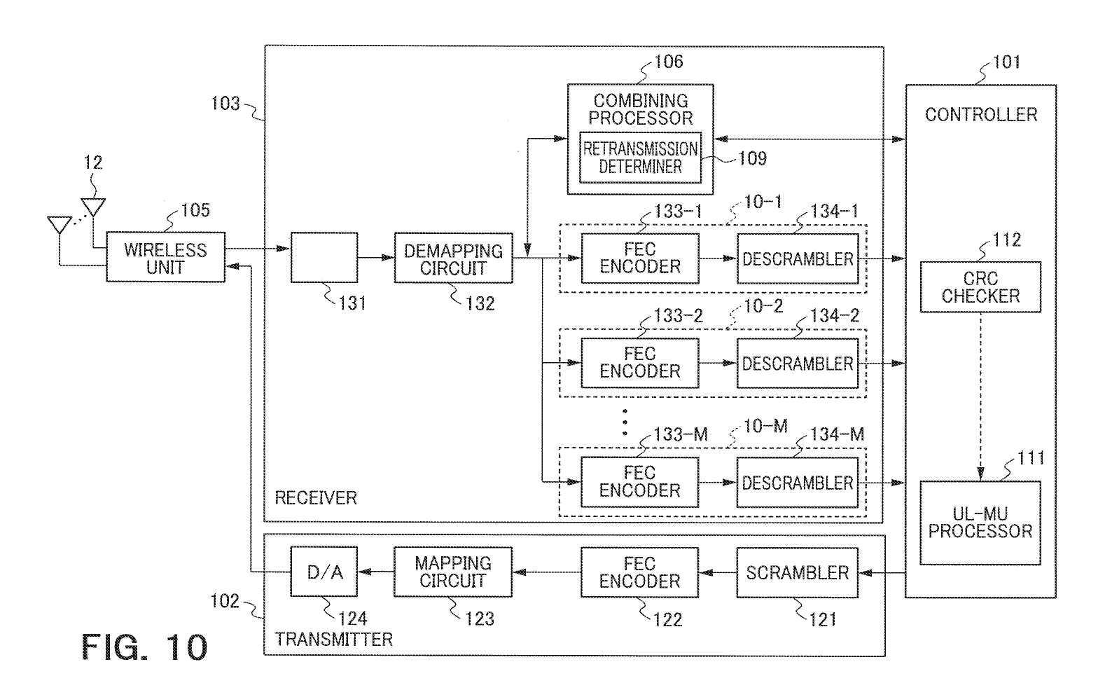

FIG. 10 illustrates a configuration of a wireless communication device included in an access point according to the other example of the embodiment. The combining processor 106 includes a re-transmission determiner 109 configured to determine whether or not a packet received at this time is a retransmitted packet. In an example, functions of the re-transmission determiner 109 may be included in the combiner 55 or may be provided in a different block.

Before combining the likelihood information LLR1 with the likelihood information LLR2 with respect to any of the combining target terminals, the re-transmission determiner 109 determines whether or not the packet received at this time is a retransmitted packet by comparing the likelihood information LLR1 with the likelihood information LLR2. When the re-transmission determiner 109 has determined that the packet received at this time is a retransmitted packet, combined likelihood information is generated by combining the likelihood information LLR1 with the likelihood information LLR2 and is supplied to the corresponding decode processor 10-A. On the contrary, when the re-transmission determiner 109 has determined that the packet received at this time is not a retransmitted packet, the combining process is not performed, but the likelihood information belonging to the combining target field of the packet received at this time (the likelihood information stored in the memory 2 of the memory unit corresponding to the reception at this time) is deleted. The decode processor 10-A does not decode any packets. With these arrangements, the electric power consumption can be reduced by eliminating unnecessary combining and decode processes. In contrast, similarly to the embodiments described above, the decode processor 10-B performs the decode process on the basis of the likelihood information of the packet received at this time, regardless of whether the check result indicates a retransmitted packet or not.

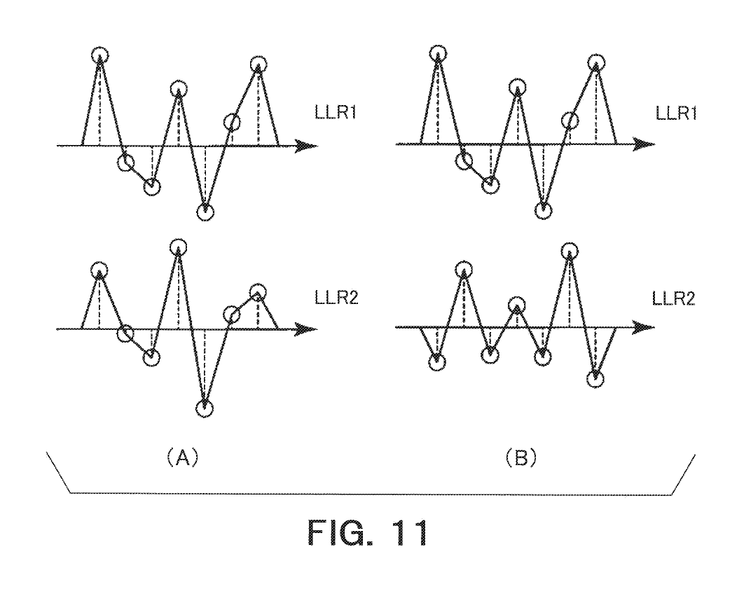

FIGS. 11 (A) and 11(B) are drawings for explaining an operation in the method used for determining whether a packet is retransmitted packet or not by comparing likelihood information. The circles (0) in the drawings each represent a piece of likelihood information and includes a sign and an amplitude. The sign is positive in the area above the horizontal axis, whereas the sign is negative in the area below the horizontal axis. The distance from each of the circles to the horizontal axis indicates an amplitude. In FIG. 11(A), because the sequence (the alignment) of the pieces of likelihood information LLR1 is similar to the sequence of the pieces of likelihood information LLR2, the packet is determined to be a retransmitted packet. In FIG. 11(B), because the sequences are not similar to each other, the packet is determined not to be a retransmitted packet (determined to be a new packet). The method used for determining whether the sequences are similar or not may be an arbitrary one. It is acceptable to use a method by which the sequences are determined to be similar to each other when the number of signs in the pieces of likelihood information that are the same between the two sequences is equal to or larger than a threshold value, while the sum of differences in the amplitudes between the two sequences is smaller than a threshold value. Alternatively, it is also acceptable to determine a degree of similarity between the waveform representing the sequence of LLR1 and the waveform representing the sequence of LLR2, by using a commonly-used waveform similarity determination method. Each of the pieces of likelihood information used in the determination process may have an arbitrary number of bits.

### Fifth Modification Example

In the embodiments described above, it is assumed that the scramble seeds are the same for the first-time packet and the retransmitted packet; however, another arrangement is also acceptable in which the scramble seeds are different between the first-time packet and the retransmitted packet. When different scramble seeds are used, the locations in which “0s” and “1s” are interchanged by the scrambler 121 will be different. Accordingly, even the packet transmitted at the first time and the retransmitted packet have the same data, those packets are received as totally different pieces of data. Consequently, even when the pieces of likelihood information are combined, the quality of the reception signals would not be improved.

To cope with this situation, the following configuration may be added for the purpose of making the embodiments described above work, even when the scramble seed is changed at the time of a re-transmission process: In one example, when a first-time packet is received, an FEC (decode) process and a descramble process are performed by using a soft value (a code and an amplitude), so that a result of the descramble process (a soft value) is stored into a storage. When a retransmitted packet is received, a scramble process is performed on the stored scramble result of the first-time packet by using the same scramble seed as the one used for the retransmitted packet, and the result thereof is encoded. The scramble process and the encode process are performed by using a soft value. The result of the encode process (the soft value) is equivalent to the likelihood information of a packet transmitted after the first-time transmission data is scrambled by using the same scramble seed as the one used for the retransmitted packet. For this reason, by combining the result of the encode process with the likelihood information of the retransmitted packet, it is possible to enhance the reliability of the reception signals.

In another example, the following configuration may be added: Conversion data is generated from the scramble seed for the first-time transmission and the scramble seed for the re-transmission process. By converting the signs in the likelihood information of either the first-time packet or the retransmitted packet with the use of the conversion data, the likelihood information after the sign conversion is arranged to have the same alignment of signs with the likelihood information of either the retransmitted packet or the first-time packet. After that, the pieces of likelihood information of the two packets are combined together. More specifically, at first, the conversion data is generated in the following manner: An exclusive OR is calculated between the scramble seed of the first-time packet and the scramble seed of the retransmitted packet. A seed, which is the value of the calculated exclusive OR, is supplied to a scrambler to which a zero sequence (0, 0, 0, 0, . . . :0s are successively arranged as long as the packet length) is input as input data. The scrambler has the same configuration as that of the scrambler 121. An output of the scrambler is supplied to an FEC encoder having the same structure as that of the FEC encoder 122, so as to perform an error correction encode process. An output of the FEC encoder serves as the conversion data. After that, the signs of the likelihood information of the first-time packet are converted, in accordance with the conversion data. At this time, the amplitude of the likelihood information does not change. The signs of the likelihood information are converted in accordance with the conversion data, by inverting the sign of the likelihood information when the conversion data is “1” and not inverting the sign of the likelihood information when the conversion data is “0”. The likelihood information resulting from the sign conversion is combined with the likelihood information of the retransmitted packet. Combined likelihood information is thus obtained. According to this configuration, because the sign conversion process is a binary process, it is possible to keep the scale of the circuit small. Further, it is possible to combine the likelihood information of the first-time packet with the likelihood information of the retransmitted packet, by using the configuration that is simpler than the configuration described above.

### (Others)

Below, a format of a trigger frame, a format of M-BA frame, UL-OFDMA and UL-MU-MIMO are described in detail.

### [Trigger Frame]

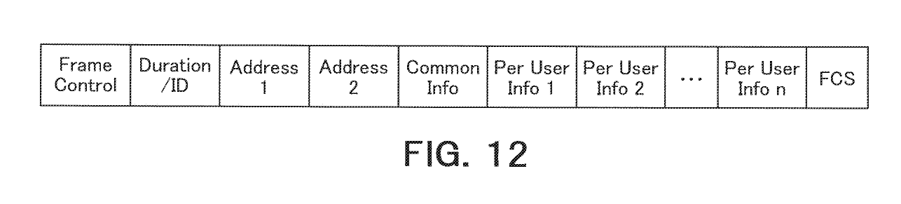

FIG. 12 is a diagram showing an exemplary format of the trigger frame. This has a format of a general MAC frame as a base shown in FIG. 2 and includes Frame Control field, Duration/ID field, Address 1 field, and Address 2 field, the common information field (Common Info.) field, plural terminal information (Per User Info.) fields and FCS field. The frame is specified to be the trigger frame by the Type and Subtype fields in Frame Control field. The Type is “control” as an example, and the Subtype may define a new value corresponding to the trigger frame. However, the trigger frame can be defined with the Type being “management” or “data”. Note that, instead of defining a new value as the Subtype, a reserved field of the MAC header can be used as a field notifying that a frame is the trigger frame.

Address 1 field may be set to a broadcast address or a multicast address as an RA. Address 2 field may be set to a MAC address of the access point (BSSID) as a TA. However, Address 1 field or Address 2 field, or both of them may be omitted in some cases. The common information field is set to notify information common to the plural terminals to which UL-MU transmission is designated. For example, information specifying a format of the terminal information field, information specifying a length of the packet transmitted in response, information representing an intended purpose (or use application) of the trigger frame, and information specifying a type of the frame to be transmitted in response to the trigger frame can be also set therein. Information on a recommended AC or a specified AC as AC to which data to be transmitted belongs may be set therein. Information on the number of the terminal information fields can be also set therein. Also, when multiple terminals belong to the same group identified by its group ID, the group ID may be set.

Information (identifiers of terminals such as AID) specifying the terminals for UL-MU transmission, and parameter information individually notified to the terminals are set in the terminal information fields. For example, a piece of information regarding the resource to be used by the terminal in UL-MU transmission is specified. Also, pieces of information specifying the transmission power to be used by the terminal, MCS, and the like may be set. The terminal that received the trigger frame carries out UL-MU transmission in accordance with the parameter information specified by the common information field and the terminal information field in which the identifier of the terminal itself is set. There are cases where the identifier of the terminal is omitted from the terminal information field, for example, a case where the group ID is set in the common information field.

### (Multi-STA BA Frame)

The Multi-STA BA frame is obtained by diverting the Block Ack frame (BA frame) thereto in order to make the acknowledgement to plural terminals by one frame. A frame type may be “Control” similarly to the ordinary BA frame, and a frame subtype may be “BlockAck”. FIG. 13(A) shows an exemplary frame format of the Multi-STA BA frame. FIG. 13(B) shows an exemplary frame format of a BA Control field of the BA frame, and FIG. 13(C) shows an exemplary frame format of a BA Information field of the BA frame. In the case of reusing the BA frame, an indication may be in the BA Control field that the BA frame format is that extended for notifying the acknowledgement response regarding the plural wireless terminals. For example, in IEEE802.11 standard, a case where a Multi-TID subfield is 1 and a Compressed Bitmap subfield is 0 is reserved. This may be used in order to indicate that the BA frame format is extended for notifying the acknowledgement response regarding to plural wireless terminals. Alternatively, an area of bits B3-B8 is a reserved subfield in FIG. 13(B), but all or a part of this area may be defined in order to indicate that the BA frame format is that extended for notifying the acknowledgement response regarding to plural wireless terminals. Alternatively, the notification as described here may not be necessarily made explicitly.

The RA field of the Multi-STA BA frame may be set to a broadcast address or a multicast address as an example. A Multi-User subfield in the BA Control field may be set to the number of the users (number of the terminals) to be reported by means of the BA Information field. In the BA Information field, there are arranged for each user (terminal), an Association ID subfield, a Block Ack Starting Sequence Control subfield, and a Block Ack Bitmap subfield.

The Association ID subfield is set to the AID for identifying the user. More specifically, as an example, a part of a Per TID Info field is used as the subfield for the Association ID as shown in FIG. 13(C). Currently, 12 bits (from B0 to B11) are a reserved area. The first 11 bits (B0-B10) of these are used as the subfield for the Association ID. The Block Ack Starting Sequence Control subfield and the Block Ack Bitmap subfield may be omitted if the frame transmitted by the terminal is a single data frame (that is, it is not an aggregation frame). As another example, a partial state operation may be used and a corresponding sequence number may be expressed in the Block Ack Bitmap subfield. If the frame transmitted by the terminal is an aggregation frame, the Block Ack Starting Sequence Control subfield has stored therein a sequence number of the first MSDU (medium access control (MAC) service data unit) in the acknowledgement response shown by the Block Ack frame. In the Block Ack Bitmap subfield, a bitmap (Block Ack Bitmap) constituted by bits each showing reception success or failure for the sequence numbers subsequent to the Block Ack Starting Sequence number is set.

### [OFDMA]

OFDMA is a communication scheme by which either transmissions to the plurality of terminals or receptions from the plurality of terminals are simultaneously performed, by allocating a plurality of resource units each including one or more sub-carriers to the terminals. The resource unit is a frequency component as the smallest unit of a communication resource.

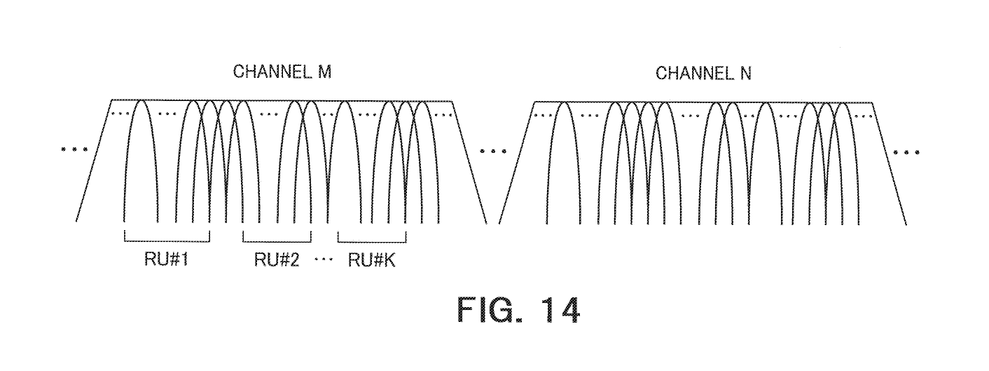

FIG. 14 illustrates the resource units (RU#1, RU#2 . . . RU#K) arranged within a continuous frequency domain of one channel (which is described here as the channel M). A plurality of subcarriers orthogonal to each other are arranged in the channel M, and a plurality of resource units including one or a plurality of continuous subcarriers are defined within the channel M. Although one or more subcarriers (guard subcarriers) may be arranged between the resource units, presence of the guard subcarrier is not essential. A number for identification of the subcarrier or the resource unit may be assigned to each carrier or each resource unit in the channel. The bandwidth of one channel may be for example, though not limited to these, 20 MHz, 40 MHz, 80 MHz, and 160 MHz. One channel may be constituted by combining a plurality of channels of 20 MHz. The number of subcarriers in the channel or the number of resource units may vary in accordance with the bandwidth. OFDMA communication is realized by different resource units being simultaneously used by different terminals.

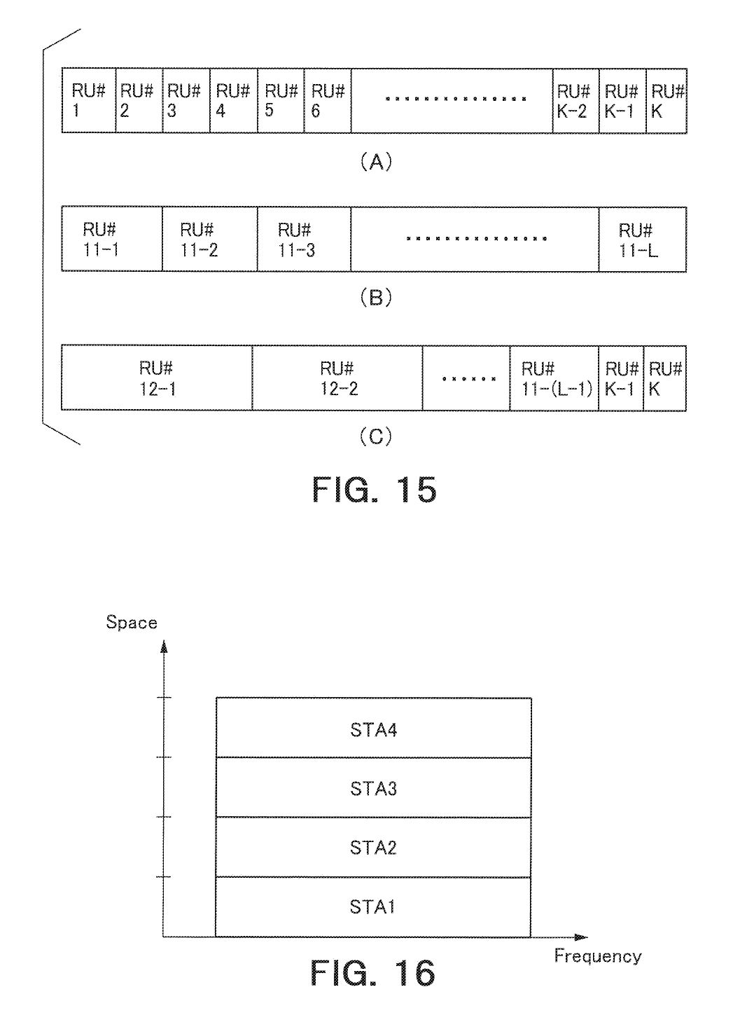

The bandwidths of the resource units (or the number of the subcarriers) may be same among the resource units, or the bandwidths (or the number of the subcarriers) may vary depending on the individual resource units. An exemplary arrangement pattern of the resource units within one channel is schematically illustrated in FIG. 15. The width direction on the paper surface corresponds to the frequency domain direction. FIG. 15(A) illustrates an example where a plurality of resource units (RU#1, RU#2 . . . RU#K) having the same bandwidth are arranged, and FIG. 15(B) illustrates another example where a plurality of resource units (RU#11-1, RU#11-2 . . . RU#11-L) having a larger bandwidth than that of FIG. 15(A) are arranged. FIG. 15(C) illustrates a still another example where resource units with three types of bandwidths are arranged. The resource units (RU#12-1, RU#12-2) have the largest bandwidth, the resource unit RU#11-(L−1) has the bandwidth identical to that of FIG. 15(B), and the resource units (RU#K−1, RU#K) have the bandwidth identical to that of FIG. 15(A).

A specific example is illustrated. When the entire 20 MHz channel width is used, 26 tones of the total 256 subcarriers (tones) may be allocated for a single RU within the 20 MHz channel width. In other words, nine resource units are specified in the 20 MHz channel width and the bandwidth of the resource unit becomes smaller than the 2.5 MHz width. In the case of a 40 MHz channel width, 18 resource units are specified. In the case of an 80 MHz channel width, 37 resource units are specified. When this is extended, for example, in the case of a 160 MHz channel width or an 80+80 MHz channel width, 74 resource units are specified. It should be noted that the width of the resource unit is not limited to a particular value and resource units of various sizes can be arranged.

Here, the number of resource units used by each terminal is not limited to a particular value and one or a plurality of resource units may be used. When a terminal uses a plurality of resource units, a plurality of resource units that are continuous in terms of frequency may be used, or a plurality of resource units that are located at positions away from each other may be allowed to be used. The resource unit #11-1 in FIG. 15(B) may be regarded as one example of a resource unit bonding the resource units #1 and #2 in FIG. 15(A).

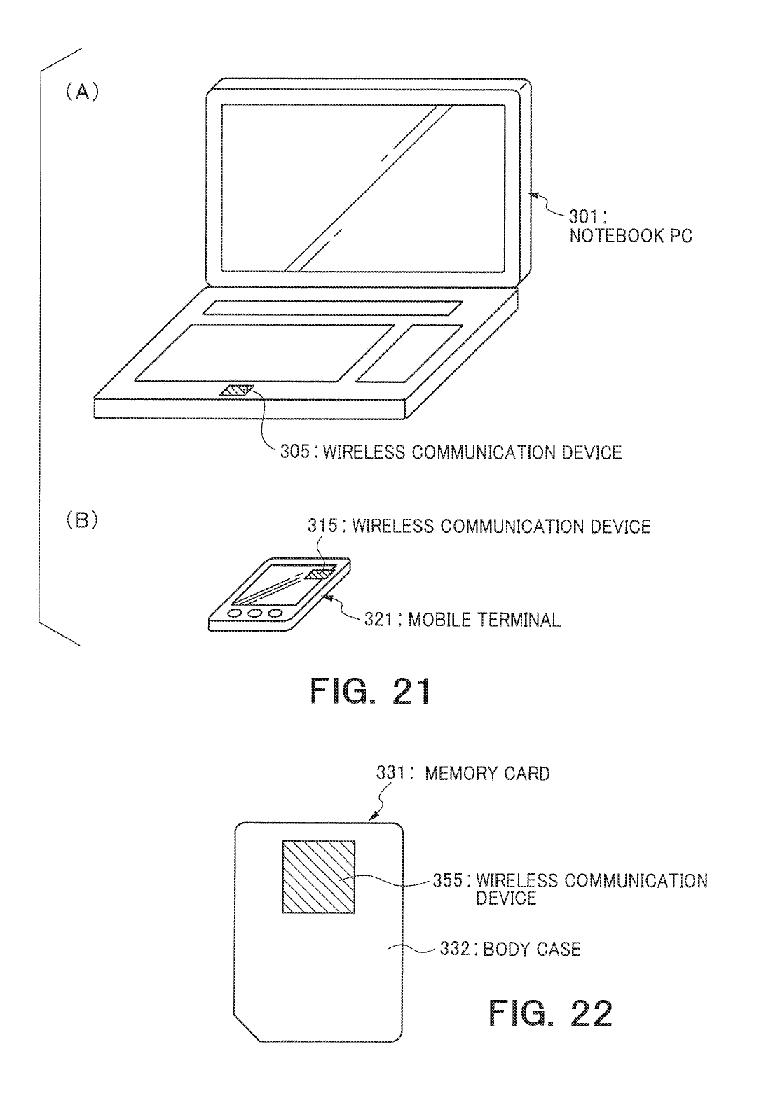

It is assumed here that subcarriers within one resource unit are continuous in the frequency domain. However, resource units may be defined with use of a plurality of subcarriers that are arranged in a non-continuous manner. The channels used in uplink OFDMA communication are not limited to one single channel but resource units may be reserved in another channel (see the channel N in FIG. 21, for example) arranged at a location away in the frequency domain from the channel M as the case of the channel M and thus the resource units in both the channel M and the channel N may be used. The same or different modes of arranging the resource units may be used for the channel M and the channel N. The bandwidth of the channel N is by way of example 20 MHz, 40 MHz, 80 MHz, 160 MHz, etc. as described above but not limited to them. It is also possible to use three or more channels. It is considered here that the combining of the channel M and the channel N may be regarded as one single channel.

The carrier sense may encompass both physical carrier sense associated with busy/idle of CCA (Clear Channel Assessment) and Virtual Carrier Sense based on medium reserve time described in the received frame. As in the case of the latter, a scheme for virtually determining that a medium is in the busy state, or the term during which the medium is virtually regarded as being in the busy state is called Network Allocation Vector (NAV). Here, carrier sense information based on CCA or NAV carried out in a unit of a channel may be universally applied to all the resource units within the channel. For example, resource units belonging to the channel indicated as idle by the carrier sense information are all in the idle state.

With regard to OFDMA, channel-based OFDMA is also possible in addition to the above-described resource-unit-based OFDMA. OFDMA of this case may in particular be called MU-MC (Multi-User Multi-Channel). In MU-MC, an access point assigns a plurality of channels (one channel width is, for example, 20 MHz, etc.) to a plurality of terminals, and the plurality of channels are simultaneously used to carry out simultaneous transmissions to the plurality of terminals or simultaneous receptions from the plurality of terminals.

### [UL-MU-MIMO]

UL-MU-MIMO is a scheme intended to make uplink transmissions more efficient, by arranging the plurality of terminals to each transmit (by a spatially multiplexing transmission) a frame to the access point by using mutually-the-same timing and mutually-the-same frequency band. FIG. 16 is a drawing for explaining a concept of MU-MIMO. Let us discuss an example in which the access point performs a UL-MU-MIMO communication with four terminals, namely the terminals 1 to 4. The terminals 1 to 4 simultaneously transmit frames by using mutually-the-same channel (of which the bandwidth may be arbitrary, such as 20 MHz, 40 MHz, or 80 MHz). The access point receives these frames at the same time, but is capable of separating these frames by using a preamble signal contained in a physical header of each of the frames. Details of this capability will be explained in detail below.

The access point receives the frames transmitted from the terminals by UL-MU-MIMO, as simultaneously-multiplexed signals. When implementing the UL-MU-MIMO scheme, the access point needs to spatially separate the frames of the plurality of terminals from the signals that were simultaneously received from the terminals. For this purpose, the access point utilizes a channel response of the uplink with each of the plurality of terminals. The access point is capable of estimating the channel responses of the uplinks with the terminals by using the preamble signal added on the head side of the frame transmitted by each of the terminals. More specifically, each of the preamble signals is contained in a preamble signal field within the physical header positioned on the head side of the frame.

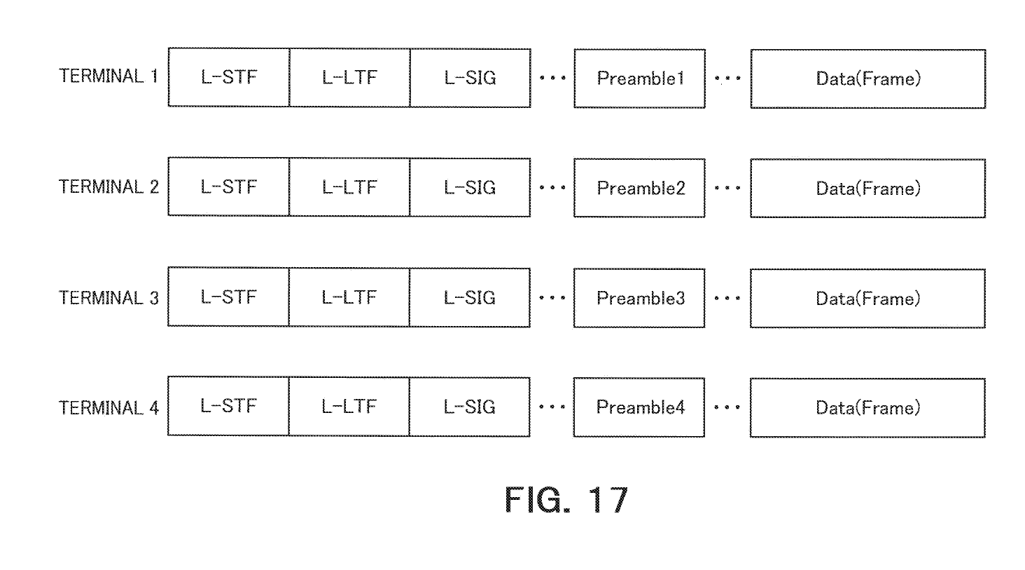

FIG. 17 illustrates examples of configurations of physical packets containing the frames transmitted by the terminals 1 to 4. As illustrated in FIG. 17, each of the preamble signals is disposed in the preamble signal field positioned between an L-SIG field and a frame. Preamble signals 1 to 4 of the terminals 1 to 4 are orthogonal to one another. The fields disposed to the front of each of the preamble signals 1 to 4, such as a Legacy-Short Training Field (L-STF), a Legacy-Long Training Field (L-LTF), and a Legacy Signal Field (L-SIG) are fields that are recognizable by a terminal compliant with a legacy standard such as one in IEEE 802.11a, for example, and have stored therein information related to signal detection, frequency correction (channel estimation), and a transmission rate. The L-STF, the L-LTF, and the L-SIG are the same signals among the plurality of terminals performing the UL-MU-MIMO transmission. The preamble signals described above correspond to an example of a communication resource according to the present embodiment. Next, the preamble signals will be explained.

Each of the preamble signals is configured with either a known bit string or a known symbol string. By estimating the channel responses of the uplinks by using the known bit string, the access point is able to spatially separate (decode) the fields properly that are positioned to the rear of the preamble signals. It is possible to realize the spatial separation by using any of the well-known arbitrary methods such as Zero-Forcing (ZF) method, Minimum Mean Square Error (MMSE) method, and maximum likelihood estimation method, for example. In an example, each of the preamble signals is disposed in the physical header (PHY header) positioned on the head side of the MAC frame. In any of the fields positioned to the front of the preamble signals within the physical headers, because signals that are mutually the same are transmitted from the terminals, the access point is able to decode these signals even when the signals are received simultaneously. Further, the preamble signals from the terminals are orthogonal to one another. For this reason, the access point is able to individually recognize each of the preamble signals simultaneously received from the terminals. Accordingly, the access point is able to estimate the uplink channels from the terminals to the access point by using the preamble signals each corresponding to a different one of the terminals. Even though the signals that are mutually different among the terminals are transmitted in the portions positioned to the rear of the preamble signals, the access point is able to separate these signals by utilizing the estimated channel responses.

As a method for arranging the preamble signals among the terminals to be orthogonal to one another, it is possible to use any of the following methods: a time method, a frequency method, and a code method. When a time orthogonalization method is used, the preamble signal field is divided into a plurality of sections, so that the preamble signals from the terminals are transmitted in mutually-different sections. It means that in any one of the sections, only one terminal is transmitting a preamble signal. In other words, while one of the terminals is transmitting a preamble signal, the other terminals are in the time period of transmitting nothing. When the frequency orthogonalization method is used, the terminals transmit preamble signals at frequencies that are in an orthogonal relationship with one another. When the code orthogonalization method is used, the terminals transmit signals having disposed therein value sequences (or, more specifically, symbol sequences corresponding to the value sequences) contained in mutually-different rows (or mutually-different columns) of an orthogonal matrix. The rows (or the columns) of the orthogonal matrix are in an orthogonal relationship with one another. By using any of these orthogonalization methods, the access point is able to recognize the preamble signals of the terminals.

In order for the terminals to use the preamble signals that are orthogonal to one another, the access point needs to provide the terminals with information about the preamble signals to be used by the terminals and the transmission methods therefore. This information corresponds to a resource to be used in UL-MU-MIMO. More specifically, it is necessary to provide information (resource information) such as the timing with which the terminals each transmit the preamble signal (where the preamble signals may be mutually the same or mutually different among the terminals) when the time orthogonalization method is used; the frequency at which the terminals each transmit the preamble signal (where the preamble signals may be mutually different or mutually the same among the terminals) when the frequency orthogonalization method is used; or what code pattern (a pattern of which row/column in the orthogonal matrix) is to be used for transmitting the preamble signals when the code orthogonalization method is used.

### Second Embodiment

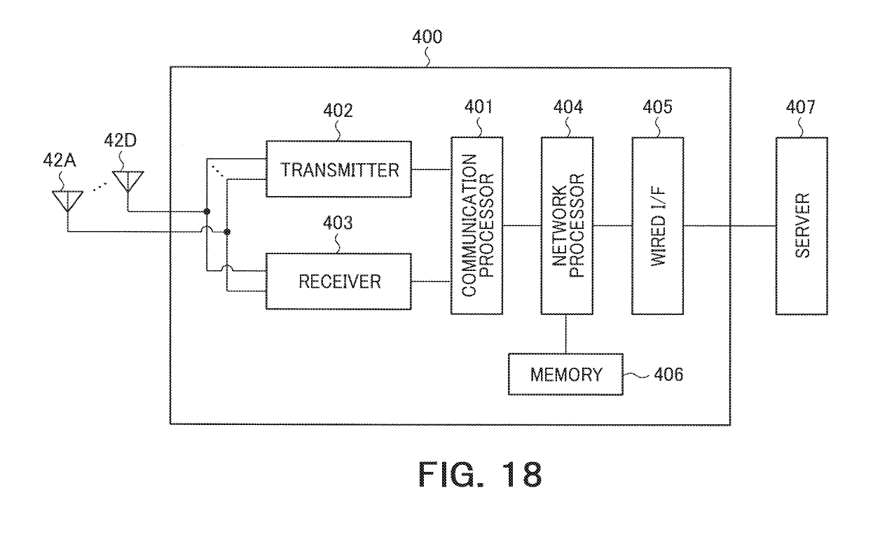

FIG. 18 is a functional block diagram of a base station (access point) 400 according to the present embodiment. The access point includes a communication processor 401, a transmitter 402, a receiver 403, antennas 42A, 42B, 42C, and 42D, a network processor 404, a wired I/F 405, and a memory 406. The access point 400 is connected to a server 407 through the wired I/F 405. The communication processor 401 has functions similar to the controller described in the first embodiment. The transmitter 402 and the receiver 403 have functions similar to the WLAN transmitter and the WLAN receiver described in the first embodiment. The network processor 404 has functions similar to the controller and the upper layer processor. The communication processor 401 may internally possess a buffer for transferring data to and from the network processor 404. The buffer may be a volatile memory, such as an SRAM or a DRAM, or may be a non-volatile memory, such as a NAND or an MRAM.

The network processor 404 controls data exchange with the communication processor 401, data writing and reading to and from the memory 406, and communication with the server 407 through the wired I/F 405. The network processor 404 may execute a higher communication process of the MAC layer, such as TCP/IP or UDP/IP, or a process of the application layer. The operation of the network processor may be performed through processing of software (program) by a processor, such as a CPU. The operation may be performed by hardware or may be performed by both of the software and the hardware.

For example, the communication processor 401 corresponds to a baseband integrated circuit, and the transmitter 402 and the receiver 403 correspond to an RF integrated circuit that transmits and receives frames. The communication processor 401 and the network processor 404 may be formed by one integrated circuit (one chip). Parts that execute processing of digital areas of the transmitter 402 and the receiver 403 and parts that execute processing of analog areas may be formed by different chips. The communication processor 401 may execute a higher communication process of the MAC layer, such as TCP/IP or UDP/IP. Although the number of antennas is four here, it is only necessary that at least one antenna is included.

The memory 406 saves data received from the server 407 and data received by the receiver 402. The memory 406 may be, for example, a volatile memory, such as a DRAM, or may be a non-volatile memory, such as a NAND or an MRAM. The memory 406 may be an SSD, an HDD, an SD card, an eMMC, or the like. The memory 406 may be provided outside of the base station 400.

The wired I/F 405 transmits and receives data to and from the server 407. Although the communication with the server 407 is performed through a wire in the present embodiment, the communication with the server 407 may be performed wirelessly. In this case, a wireless I/F may be employed instead of the wired I/F 405.

The server 407 is a communication device that returns a response including requested data in response to reception of a data forward request for requesting transmission of the data. Examples of the server 407 include an HTTP server (Web server) and an FTP server. However, the server 407 is not limited to these as long as the server 407 has a function of returning the requested data. The server 407 may be a communication device operated by the user, such as a PC or a smartphone.

When the STA belonging to the BSS of the base station 400 issues a forward request of data for the server 407, a packet regarding the data forward request is transmitted to the base station 400. The base station 400 receives the packet through the antennas 42A to 42D. The base station 400 causes the receiver 403 to execute the process of the physical layer and the like and causes the communication processor 401 to execute the process of the MAC layer and the like.

The network processor 404 analyzes the packet received from the communication processor 401. Specifically, the network processor 404 checks the destination IP address, the destination port number, and the like. When the data of the packet is a data forward request such as an HTTP GET request, the network processor 404 checks whether the data requested by the data forward request (for example, data in the URL requested by the HTTP GET request) is cached (stored) in the memory 406. A table associating the URL (or reduced expression of the URL, such as a hash value or an identifier substituting the URL) and the data is stored in the memory 406. The fact that the data is cached in the memory 406 will be expressed that the cache data exists in the memory 406.

When the cache data does not exist in the memory 406, the network processor 404 transmits the data forward request to the server 407 through the wired I/F 405. In other words, the network processor 404 substitutes the STA to transmit the data forward request to the server 407. Specifically, the network processor 404 generates an HTTP request and executes protocol processing, such as adding the TCP/IP header, to transfer the packet to the wired I/F 405. The wired I/F 405 transmits the received packet to the server 407.

The wired I/F 405 receives, from the server 407, a packet that is a response to the data forward request. From the IP header of the packet received through the wired I/F 405, the network processor 404 figures out that the packet is addressed to the STA and transfers the packet to the communication processor 401. The communication processor 401 executes processing of the MAC layer and the like for the packet. The transmitter 402 executes processing of the physical layer and the like and transmits the packet addressed to the STA from the antennas 42A to 42D. The network processor 404 associates the data received from the server 407 with the URL (or reduced expression of the URL) and saves the cache data in the memory 406.

When the cache data exists in the memory 406, the network processor 404 reads the data requested by the data forward request from the memory 406 and transmits the data to the communication processor 401. Specifically, the network processor 404 adds the HTTP header or the like to the data read from the memory 406 and executes protocol processing, such as adding the TCP/IP header, to transmit the packet to the communication processor 401. In this case, the transmitter IP address of the packet is set to the same IP address as the server, and the transmitter port number is also set to the same port number as the server (destination port number of the packet transmitted by the communication terminal), for example. Therefore, it can be viewed from the STA as if communication with the server 407 is established. The communication processor 401 executes processing of the MAC layer and the like for the packet. The transmitter 402 executes processing of the physical layer and the like and transmits the packet addressed to the STA from the antennas 42A to 42D.

According to the operation, frequently accessed data is responded based on the cache data saved in the memory 406, and the traffic between the server 407 and the base station 400 can be reduced. Note that the operation of the network processor 404 is not limited to the operation of the present embodiment. There is no problem in performing other operation when a general caching proxy is used, in which data is acquired from the server 407 in place of the STA, the data is cached in the memory 406, and a response is made from the cache data of the memory 406 for a data forward request of the same data.

The base station (access point) according to the present invention can be applied for the base station in the first embodiment. The transmission of the frame, the data or the packet used in the first embodiment may be carried out based on the cached data stored in the memory 406. Also, information obtained based on the frame, the data or the packet received by the base station in the first embodiment may be cached in the memory 406. The frame transmitted by the base station in the first embodiment may include the cached data or information based on the cached data. The information based on the cached data may include information on a size of the data, a size of a packet required for transmission of the data. The information based on the cached data may include a modulation scheme required for transmission of the data. The information based on the cached data may include information on existence or non-existence of data addressed to the terminal,

In the present embodiment, although the base station with the cache function is described, a terminal (STA) with the cache function can also be realized by the same block configuration as FIG. 18. In this case, the wired I/F 405 may be omitted. The transmission, by the terminal, of the frame, the data or the packet used in first embodiment may be carried out based on the cached data stored in the memory 406. Also, information obtained based on the frame, the data or the packet received by the terminal in first embodiment may be cached in the memory 406. The frame transmitted by the terminal in the first embodiment may include the cached data or information based on the cached data. The information based on the cached data may include information on a size of the data, a size of a packet required for transmission of the data. The information based on the cached data may include a modulation scheme required for transmission of the data. The information based on the cached data include information on existence or non-existence of data addressed to the terminal.

### Third Embodiment

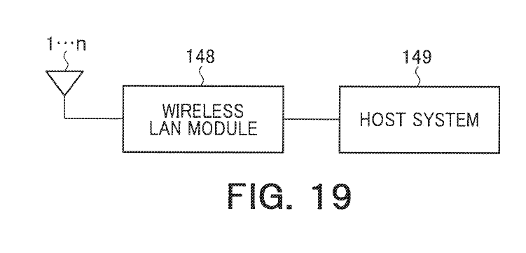

FIG. 19 shows an example of entire configuration of a terminal or a base station. The example of configuration is just an example, and the present embodiment is not limited to this. The terminal or the base station includes one or a plurality of antennas 1 to n (n is an integer equal to or greater than 1), a wireless LAN module 148, and a host system 149. The wireless LAN module 148 corresponds to the wireless communication device according to the first embodiment. The wireless LAN module 148 includes a host interface and is connected to the host system 149 through the host interface. Other than the connection to the host system 149 through the connection cable, the wireless LAN module 148 may be directly connected to the host system 149. The wireless LAN module 148 can be mounted on a substrate by soldering or the like and can be connected to the host system 149 through wiring of the substrate. The host system 149 uses the wireless LAN module 148 and the antennas 1 to n to communicate with external apparatuses according to an arbitrary communication protocol. The communication protocol may include the TCP/IP and a protocol of a layer higher than that. Alternatively, the TCP/IP may be mounted on the wireless LAN module 148, and the host system 149 may execute only a protocol in a layer higher than that. In this case, the configuration of the host system 149 can be simplified. Examples of the present terminal include a mobile terminal, a TV, a digital camera, a wearable device, a tablet, a smartphone, a game device, a network storage device, a monitor, a digital audio player, a Web camera, a video camera, a projector, a navigation system, an external adaptor, an internal adaptor, a set top box, a gateway, a printer server, a mobile access point, a router, an enterprise/service provider access point, a portable device, a hand-held device, and so on.

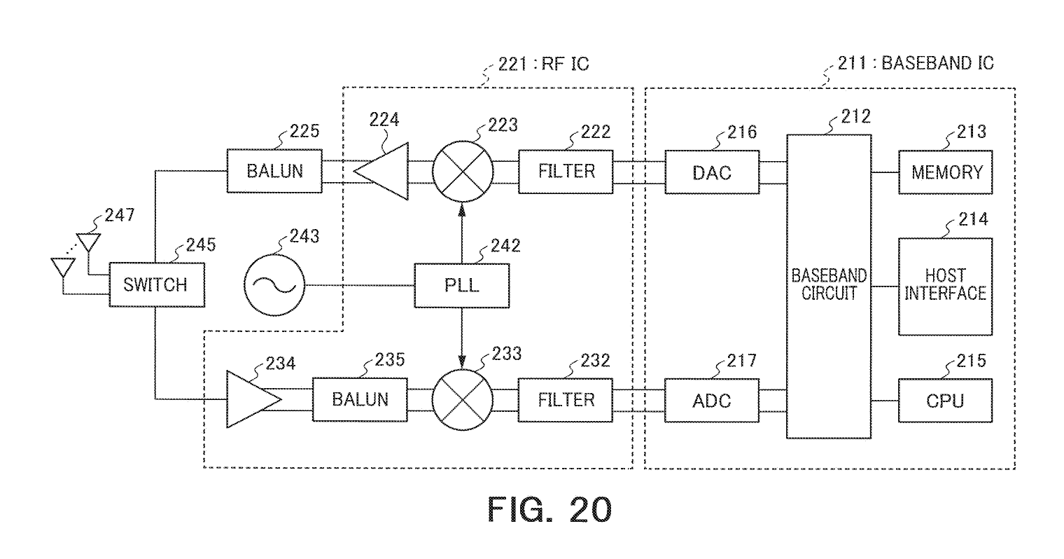

FIG. 20 shows an example of hardware configuration of a wireless LAN module. The configuration can also be applied when the wireless communication device is mounted on either one of the terminal that is a non-base station and the base station. Therefore, the configuration can be applied as an example of specific configuration of the wireless communication device shown in FIG. 4. At least one antenna 247 is included in the example of configuration. When a plurality of antennas are included, a plurality of sets of a transmission system (216 and 222 to 225), a reception system (217, 232 to 235), a PLL 242, a crystal oscillator (reference signal source) 243, and a switch 245 may be arranged according to the antennas, and each set may be connected to a control circuit 212. One or both of the PLL 242 and the crystal oscillator 243 correspond to an oscillator according to the present embodiment.

The wireless LAN module (wireless communication device) includes a baseband IC (Integrated Circuit) 211, an RF (Radio Frequency) IC 221, a balun 225, the switch 245, and the antenna 247.

The baseband IC 211 includes the baseband circuit (control circuit) 212, a memory 213, a host interface 214, a CPU 215, a DAC (Digital to Analog Converter) 216, and an ADC (Analog to Digital Converter) 217.

The baseband IC 211 and the RF IC 221 may be formed on the same substrate. The baseband IC 211 and the RF IC 221 may be formed by one chip. Both or one of the DAC 216 and the ADC 217 may be arranged on the RF IC 221 or may be arranged on another IC. Both or one of the memory 213 and the CPU 215 may be arranged on an IC other than the baseband IC.

The memory 213 stores data to be transferred to and from the host system. The memory 213 also stores one or both of information to be transmitted to the terminal or the base station and information transmitted from the terminal or the base station. The memory 213 may also store a program necessary for the execution of the CPU 215 and may be used as a work area for the CPU 215 to execute the program. The memory 213 may be a volatile memory, such as an SRAM or a DRAM, or may be a non-volatile memory, such as a NAND or an MRAM.

The host interface 214 is an interface for connection to the host system. The interface can be anything, such as UART, SPI, SDIO, USB, or PCI Express.

The CPU 215 is a processor that executes a program to control the baseband circuit 212. The baseband circuit 212 mainly executes a process of the MAC layer and a process of the physical layer. One or both of the baseband circuit 212 and the CPU 215 correspond to the communication control apparatus that controls communication, the controller that controls communication, or controlling circuitry that controls communication.

At least one of the baseband circuit 212 or the CPU 215 may include a clock generator that generates a clock and may manage internet time by the clock generated by the clock generator.

For the process of the physical layer, the baseband circuit 212 performs addition of the physical header, coding, encryption, modulation process, and the like of the frame to be transmitted and generates, for example, two types of digital baseband signals (hereinafter, “digital I signal” and “digital Q signal”).

The DAC 216 performs DA conversion of signals input from the baseband circuit 212. More specifically, the DAC 216 converts the digital I signal to an analog I signal and converts the digital Q signal to an analog Q signal. Note that a single system signal may be transmitted without performing quadrature modulation. When a plurality of antennas are included, and single system or multi-system transmission signals equivalent to the number of antennas are to be distributed and transmitted, the number of provided DACs and the like may correspond to the number of antennas.

The RF IC 221 is, for example, one or both of an RF analog IC and a high frequency IC. The RF IC 221 includes a filter 222, a mixer 223, a preamplifier (PA) 224, the PLL (Phase Locked Loop) 242, a low noise amplifier (LNA) 234, a balun 235, a mixer 233, and a filter 232. Some of the elements may be arranged on the baseband IC 211 or another IC. The filters 222 and 232 may be bandpass filters or low pass filters. The RF IC 221 is connected to the antenna 247 through the switch 245.

The filter 222 extracts a signal of a desired band from each of the analog I signal and the analog Q signal input from the DAC 216. The PLL 242 uses an oscillation signal input from the crystal oscillator 243 and performs one or both of division and multiplication of the oscillation signal to thereby generate a signal at a certain frequency synchronized with the phase of the input signal. Note that the PLL 242 includes a VCO (Voltage Controlled Oscillator) and uses the VCO to perform feedback control based on the oscillation signal input from the crystal oscillator 243 to thereby obtain the signal at the certain frequency. The generated signal at the certain frequency is input to the mixer 223 and the mixer 233. The PLL 242 is equivalent to an example of an oscillator that generates a signal at a certain frequency.

The mixer 223 uses the signal at the certain frequency supplied from the PLL 242 to up-convert the analog I signal and the analog Q signal passed through the filter 222 into a radio frequency. The preamplifier (PA) amplifies the analog I signal and the analog Q signal at the radio frequency generated by the mixer 223, up to desired output power. The balun 225 is a converter for converting a balanced signal (differential signal) to an unbalanced signal (single-ended signal). Although the balanced signal is handled by the RF IC 221, the unbalanced signal is handled from the output of the RF IC 221 to the antenna 247. Therefore, the balun 225 performs the signal conversions.

The switch 245 is connected to the balun 225 on the transmission side during the transmission and is connected to the LNA 234 or the RF IC 221 on the reception side during the reception. The baseband IC 211 or the RF IC 221 may control the switch 245. There may be another circuit that controls the switch 245, and the circuit may control the switch 245.

The analog I signal and the analog Q signal at the radio frequency amplified by the preamplifier 224 are subjected to balanced-unbalanced conversion by the balun 225 and are then emitted as radio waves to the space from the antenna 247.

The antenna 247 may be a chip antenna, may be an antenna formed by wiring on a printed circuit board, or may be an antenna formed by using a linear conductive element.

The LNA 234 in the RF IC 221 amplifies a signal received from the antenna 247 through the switch 245 up to a level that allows demodulation, while maintaining the noise low. The balun 235 performs unbalanced-balanced conversion of the signal amplified by the low noise amplifier (LNA) 234. The mixer 233 uses the signal at the certain frequency input from the PLL 242 to down-convert, to a baseband, the reception signal converted to a balanced signal by the balun 235. More specifically, the mixer 233 includes a unit that generates carrier waves shifted by a phase of 90 degrees based on the signal at the certain frequency input from the PLL 242. The mixer 233 uses the carrier waves shifted by a phase of 90 degrees to perform quadrature demodulation of the reception signal converted by the balun 235 and generates an I (In-phase) signal with the same phase as the reception signal and a Q (Quad-phase) signal with the phase delayed by 90 degrees. The filter 232 extracts signals with desired frequency components from the I signal and the Q signal. Gains of the I signal and the Q signal extracted by the filter 232 are adjusted, and the I signal and the Q signal are output from the RF IC 221.

The ADC 217 in the baseband IC 211 performs AD conversion of the input signal from the RF IC 221. More specifically, the ADC 217 converts the I signal to a digital I signal and converts the Q signal to a digital Q signal. Note that a single system signal may be received without performing quadrature demodulation.

When a plurality of antennas are provided, the number of provided ADCs may correspond to the number of antennas. Based on the digital I signal and the digital Q signal, the baseband circuit 212 executes a process of the physical layer and the like, such as demodulation process, error correcting code process, and process of physical header, and obtains a frame. The baseband circuit 212 applies a process of the MAC layer to the frame. Note that the baseband circuit 212 may be configured to execute a process of TCP/IP when the TCP/IP is implemented.

### Fourth Embodiment

FIG. 21(A) and FIG. 21(B) are perspective views of wireless terminal according to the fourth embodiment. The wireless terminal in FIG. 21(A) is a notebook PC 301 and the wireless communication device (or a wireless device) in FIG. 21(B) is a mobile terminal 321. Each of them corresponds to one form of a terminal (which may indicate a base station). The notebook PC 301 and the mobile terminal 321 are equipped with wireless communication devices 305 and 315, respectively. The wireless communication device provided in a terminal (which may indicate a base station) which has been described above can be used as the wireless communication devices 305 and 315. A wireless terminal carrying a wireless communication device is not limited to notebook PCs and mobile terminals. For example, it can be installed in a TV, a digital camera, a wearable device, a tablet, a smart phone, a gaming device, a network storage device, a monitor, a digital audio player, a web camera, a video camera, a projector, a navigation system, an external adapter, an internal adapter, a set top box, a gateway, a printer server, a mobile access point, a router, an enterprise/service provider access point, a portable device, a handheld device and so on.

Moreover, a wireless communication device installed in a terminal (which may indicate a base station) can also be provided in a memory card. FIG. 22 illustrates an example of a wireless communication device mounted on a memory card. A memory card 331 contains a wireless communication device 355 and a body case 332. The memory card 331 uses the wireless communication device 355 for wireless communication with external devices. Here, in FIG. 22, the description of other installed elements (for example, a memory, and so on) in the memory card 331 is omitted.

### Fifth Embodiment

In the fifth embodiment, a bus, a processor unit and an external interface unit are provided in addition to the configuration of the wireless communication device according to any of the embodiments. The processor unit and the external interface unit are connected with an external memory (a buffer) through the bus. A firmware operates the processor unit. Thus, by adopting a configuration in which the firmware is included in the wireless communication device, the functions of the wireless communication device can be easily changed by rewriting the firmware. The processing unit in which the firmware operates may be a processor that performs the process of the communication controlling device or the control unit according to the present embodiment, or may be another processor that performs a process relating to extending or altering the functions of the process of the communication controlling device or the control unit. The processing unit in which the firmware operates may be included in the base station or the wireless terminal according to the present embodiment. Alternatively, the processing unit may be included in the integrated circuit of the wireless communication device installed in the base station, or in the integrated circuit of the wireless communication device installed in the wireless terminal.

### Sixth Embodiment

In the sixth embodiment, a clock generating unit is provided in addition to the configuration of the wireless communication device according to any of the embodiments. The clock generating unit generates a clock and outputs the clock from an output terminal to the exterior of the wireless communication device. Thus, by outputting to the exterior the clock generated inside the wireless communication device and operating the host by the clock output to the exterior, it is possible to operate the host and the wireless communication device in a synchronized manner.

### Seventh Embodiment

In the seventh embodiment, a power source unit, a power source controlling unit and a wireless power feeding unit are included in addition to the configuration of the wireless communication device according to any of embodiments. The power supply controlling unit is connected to the power source unit and to the wireless power feeding unit, and performs control to select a power source to be supplied to the wireless communication device. Thus, by adopting a configuration in which the power source is included in the wireless communication device, power consumption reduction operations that control the power source are possible.

### Eighth Embodiment

In the eighth embodiment, a SIM card is added to the configuration of the wireless communication device according to any of the embodiments. For example, the SIM card is connected with the controller, the transmitter and the receiver. Thus, by adopting a configuration in which the SIM card is included in the wireless communication device, authentication processing can be easily performed.

### Ninth Embodiment

In the ninth embodiment, a video image compressing/decompressing unit is added to the configuration of the wireless communication device according to the sixteenth embodiment. The video image compressing/decompressing unit is connected to the bus. Thus, by adopting a configuration in which the video image compressing/decompressing unit is included in the wireless communication device, transmitting a compressed video image and decompressing a received compressed video image can be easily done.

### Tenth Embodiment

In the tenth embodiment, an LED unit is added to the configuration of the wireless communication device according to any of the embodiments. For example, the LED unit is connected to at least one of the controller, the transmitter or the receiver. Thus, by adopting a configuration in which the LED unit is included in the wireless communication device, notifying the operation state of the wireless communication device to the user can be easily done.

### Eleventh Embodiment

In the eleventh embodiment, a vibrator unit is included in addition to the configuration of the wireless communication device according to any of the embodiments. For example, the vibrator unit is connected to at least one of the controller, the transmitter or the receiver. Thus, by adopting a configuration in which the vibrator unit is included in the wireless communication device, notifying the operation state of the wireless communication device to the user can be easily done.

### Twelfth Embodiment

In the twelfth embodiment, the configuration of the wireless communication device includes a display in addition to the configuration of the wireless communication device (which may indicate the wireless communication device mounted in the terminal, the wireless communication device mounted in the base station or both of them) according to any one of the above embodiments. The display may be connected to the MAC processor. As seen from the above, the configuration including the display to display the operation state of the wireless communication device on the display allows the operation status of the wireless communication device to be easily notified to a user.

### Thirteenth Embodiment

In the present embodiment, [1] the frame type in the wireless communication system, [2] a technique of disconnection between wireless communication devices, [3] an access scheme of a wireless LAN system and [4] a frame interval of a wireless LAN are described.

### [1] Frame Type in Communication System

Generally, as mentioned above, frames treated on a wireless access protocol in a wireless communication system are roughly divided into three types of the data frame, the management frame and the control frame. These types are normally shown in a header part which is commonly provided to frames. As a display method of the frame type, three types may be distinguished in one field or may be distinguished by a combination of two fields. In IEEE 802.11 standard, identification of a frame type is made based on two fields of Type and Subtype in the Frame Control field in the header part of the MAC frame. The Type field is one for generally classifying frames into a data frame, a management frame, or a control frame and the Subtype field is one for identifying more detailed type in each of the classified frame types such as a beacon frame belonging to the management frame.

The management frame is a frame used to manage a physical communication link with a different wireless communication device. For example, there are a frame used to perform communication setting with the different wireless communication device or a frame to release communication link (that is, to disconnect the connection), and a frame related to the power save operation in the wireless communication device.

The data frame is a frame to transmit data generated in the wireless communication device to the different wireless communication device after a physical communication link with the different wireless communication device is established. The data is generated in a higher layer of the present embodiment and generated by, for example, a user's operation.

The control frame is a frame used to perform control at the time of transmission and reception (exchange) of the data frame with the different wireless communication device. A response frame transmitted for the acknowledgment in a case where the wireless communication device receives the data frame or the management frame, belongs to the control frame. The response frame is, for example, an ACK frame or a BlockACK frame. The RTS frame and the CTS frame are also the control frame.

These three types of frames are subjected to processing based on the necessity in the physical layer and then transmitted as physical packets via an antenna. In IEEE 802.11 standard (including the extended standard such as IEEE Std 802.11ac-2013), an association process is defined as one procedure for connection establishment. The association request frame and the association response frame which are used in the procedure are a management frame. Since the association request frame and the association response frame is the management frame transmitted in a unicast scheme, the frames causes the wireless communication terminal in the receiving side to transmit an ACK frame being a response frame. The ACK frame is a control frame as described in the above.

### [2] Technique of Disconnection Between Wireless Communication Devices

For disconnection of the connection (release), there are an explicit technique and an implicit technique. As the explicit technique, a frame to disconnect any one of the connected wireless communication devices is transmitted. This frame corresponds to Deauthentication frame defined in IEEE 802.11 standard and is classified into the management frame. Normally, it is determined that the connection is disconnected at the timing of transmitting the frame to disconnect the connection in a wireless communication device on the side to transmit the frame and at the timing of receiving the frame to disconnect the connection in a wireless communication device on the side to receive the frame. Afterward, it returns to the initial state in a communication phase, for example, a state to search for a wireless communication device of the communicating partner. In a case that the wireless communication base station disconnects with a wireless communication terminal, for example, the base station deletes information on the wireless communication device from a connection management table if the base station holds the connection management table for managing wireless communication terminals which entries into the BSS of the base station-self. For example, in a case that the base station assigns an AID to each wireless communication terminal which entries into the BSS at the time when the base station permitted each wireless communication terminal to connect to the base station-self in the association process, the base station deletes the held information related to the AID of the wireless communication terminal disconnected with the base station and may release the AID to assign it to another wireless communication device which newly entries into the BSS.

On the other hand, as the implicit technique, it is determined that the connection state is disconnected in a case where frame transmission (transmission of a data frame and management frame or transmission of a response frame with respect to a frame transmitted by the subject device) is not detected from a wireless communication device of the connection partner which has established the connection for a certain period. Such a technique is provided because, in a state where it is determined that the connection is disconnected as mentioned above, a state is considered where the physical wireless link cannot be secured, for example, the communication distance to the wireless communication device of the connection destination is separated and the radio signals cannot be received or decoded. That is, it is because the reception of the frame to disconnect the connection cannot be expected.

As a specific example to determine the disconnection of connection in an implicit method, a timer is used. For example, at the time of transmitting a data frame that requests an acknowledgment response frame, a first timer (for example, a retransmission timer for a data frame) that limits the retransmission period of the frame is activated, and, if the acknowledgement response frame to the frame is not received until the expiration of the first timer (that is, until a desired retransmission period passes), retransmission is performed. When the acknowledgment response frame to the frame is received, the first timer is stopped.

On the other hand, when the acknowledgment response frame is not received and the first timer expires, for example, a management frame to confirm whether a wireless communication device of a connection partner is still present (in a communication range) (in other words, whether a wireless link is secured) is transmitted, and, at the same time, a second timer (for example, a retransmission timer for the management frame) to limit the retransmission period of the frame is activated. Similarly to the first timer, even in the second timer, retransmission is performed if an acknowledgment response frame to the frame is not received until the second timer expires, and it is determined that the connection is disconnected when the second timer expires.

Alternatively, a third timer is activated when a frame is received from a wireless communication device of the connection partner, the third timer is stopped every time the frame is newly received from the wireless communication device of the connection partner, and it is activated from the initial value again. When the third timer expires, similarly to the above, a management frame to confirm whether the wireless communication device of the connection party is still present (in a communication range) (in other words, whether a wireless link is secured) is transmitted, and, at the same time, a second timer (for example, a retransmission timer for the management frame) to limit the retransmission period of the frame is activated. Even in this case, retransmission is performed if an acknowledgment response frame to the frame is not received until the second timer expires, and it is determined that the connection is disconnected when the second timer expires. The latter management frame to confirm whether the wireless communication device of the connection partner is still present may differ from the management frame in the former case. Moreover, regarding the timer to limit the retransmission of the management frame in the latter case, although the same one as that in the former case is used as the second timer, a different timer may be used.

### [3] Access Scheme of Wireless LAN System

For example, there is a wireless LAN system with an assumption of communication or competition with a plurality of wireless communication devices. CSMA/CA is set as the basis of an access scheme in IEEE802.11 (including an extension standard or the like) wireless LAN. In a scheme in which transmission by a certain wireless communication device is grasped and transmission is performed after a fixed time from the transmission end, simultaneous transmission is performed in the plurality of wireless communication devices that grasp the transmission by the wireless communication device, and, as a result, radio signals collide and frame transmission fails. By grasping the transmission by the certain wireless communication device and waiting for a random time from the transmission end, transmission by the plurality of wireless communication devices that grasp the transmission by the wireless communication device stochastically disperses. Therefore, if the number of wireless communication devices in which the earliest time in a random time is subtracted is one, frame transmission by the wireless communication device succeeds and it is possible to prevent frame collision. Since the acquisition of the transmission right based on the random value becomes impartial between the plurality of wireless communication devices, it can say that a scheme adopting Carrier Avoidance is a suitable scheme to share a radio medium between the plurality of wireless communication devices.

### [4] Frame Interval of Wireless LAN

The frame interval of IEEE802.11 wireless LAN is described. There are six types of frame intervals used in IEEE802.11 wireless LAN, such as distributed coordination function interframe space (DIFS), arbitration interframe space (AIFS), point coordination function interframe space (PIFS), short interframe space (SIFS), extended interframe space (EIFS) and reduced interframe space (RIFS).

The definition of the frame interval is defined as a continuous period that should confirm and open the carrier sensing idle before transmission in IEEE802.11 wireless LAN, and a strict period from a previous frame is not discussed. Therefore, the definition is followed in the explanation of IEEE802.11 wireless LAN system. In IEEE802.11 wireless LAN, a waiting time at the time of random access based on CSMA/CA is assumed to be the sum of a fixed time and a random time, and it can say that such a definition is made to clarify the fixed time

DIFS and AIFS are frame intervals used when trying the frame exchange start in a contention period that competes with other wireless communication devices on the basis of CSMA/CA. DIFS is used in a case where priority according to the traffic type is not distinguished, AIFS is used in a case where priority by traffic identifier (TID) is provided.

Since operation is similar between DIFS and AIFS, an explanation below will mainly use AIFS. In IEEE802.11 wireless LAN, access control including the start of frame exchange in the MAC layer is performed. In addition, in a case where QoS (Quality of Service) is supported when data is transferred from a higher layer, the traffic type is notified together with the data, and the data is classified for the priority at the time of access on the basis of the traffic type. The class at the time of this access is referred to as “access category (AC)”. Therefore, the value of AIFS is provided every access category.

PIFS denotes a frame interval to enable access which is more preferential than other competing wireless communication devices, and the period is shorter than the values of DIFS and AIFS. SIFS denotes a frame interval which can be used in a case where frame exchange continues in a burst manner at the time of transmission of a control frame of a response system or after the access right is acquired once. EIFS denotes a frame interval caused when frame reception fails (when the received frame is determined to be error).

RIFS denotes a frame interval which can be used in a case where a plurality of frames are consecutively transmitted to the same wireless communication device in a burst manner after the access right is acquired once, and a response frame from a wireless communication device of the transmission partner is not requested while RIFS is used.

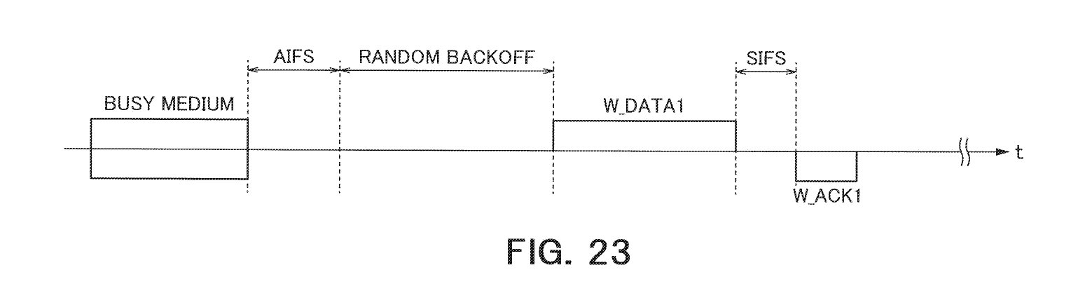

Here, FIG. 23 illustrates one example of frame exchange in a competitive period based on the random access in IEEE802.11 wireless LAN.

When a transmission request of a data frame (W_DATA1) is generated in a certain wireless communication device, a case is assumed where it is recognized that a medium is busy (busy medium) as a result of carrier sensing. In this case, AIFS of a fixed time is set from the time point at which the carrier sensing becomes idle, and, when a random time (random backoff) is set afterward, data frame W_DATA1 is transmitted to the communicating partner.

The random time is acquired by multiplying a slot time by a pseudorandom integer led from uniform distribution between contention windows (CW) given by integers from 0. Here, what multiplies CW by the slot time is referred to as “CW time width”. The initial value of CW is given by CWmin, and the value of CW is increased up to CWmax every retransmission. Similarly to AIFS, both CWmin and CWmax have values every access category. In a wireless communication device of transmission destination of W_DATA1, when reception of the data frame succeeds, a response frame (W_ACK1) is transmitted after SIFS from the reception end time point. If it is within a transmission burst time limit when W_ACK1 is received, the wireless communication device that transmits W_DATA1 can transmit the next frame (for example, W_DATA2) after SIFS.

Although AIFS, DIFS, PIFS and EIFS are functions between SIFS and the slot-time, SIFS and the slot time are defined every physical layer. Moreover, although parameters whose values being set according to each access category, such as AIFS, CWmin and CWmax, can be set independently by a communication group (which is a basic service set (BSS) in IEEE802.11 wireless LAN), the default values are defined.

For example, in the definition of 802.11ac, with an assumption that SIFS is 16 μs and the slot time is 9 μs, and thereby PIFS is 25 μs, DIFS is 34 μs, the default value of the frame interval of an access category of BACKGROUND (AC_BK) in AIFS is 79 μs, the default value of the frame interval of BEST EFFORT (AC_BE) is 43 μs, the default value of the frame interval between VIDEO(AC_VI) and VOICE(AC_VO) is 34 μs, and the default values of CWmin and CWmax are 31 and 1023 in AC_BK and AC_BE, 15 and 31 in AC_VI and 7 and 15 in AC_VO. Here, EIFS denotes the sum of SIFS, DIFS, and the time length of a response frame transmitted at the lowest mandatory physical rate. In the wireless communication device which can effectively takes EIFS, it may estimate an occupation time length of a PHY packet conveying a response frame directed to a PHY packet due to which the EIFS is caused and calculates a sum of SIFS, DIFS and the estimated time to take the EIFS.

The terms used in each embodiment should be interpreted broadly. For example, the term “processor” may encompass a general purpose processor, a central processing unit (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, or one or more microprocessors in conjunction with a DSP core.

As another example, the term “memory” may encompass any electronic component which can store electronic information. The “memory” may refer to various types of media such as a random access memory (RAM), a read-only memory (ROM), a programmable read-only memory (PROM), an erasable programmable read only memory (EPROM), an electrically erasable PROM (EEPROM), a non-volatile random access memory (NVRAM), a flash memory, and a magnetic or optical data storage, which are readable by a processor. It can be said that the memory electronically communicates with a processor if the processor read and/or write information for the memory.

The memory may be arranged within a processor and also in this case, it can be said that the memory electronically communication with the processor.

Note that the frames described in the embodiments may indicate not only things called frames in, for example, IEEE 802.11 standard, but also things called packets, such as Null Data Packets.

When it is expressed that the base station transmits or receives a plurality of frames or a plurality of X-th frames, the frames or the X-th frames may be the same (for example, the same type or the same content) or may be different. An arbitrary value can be put into X according to the situation. The plurality of frames or the plurality of X-th frames may be transmitted or received at the same time or may be transmitted or received at temporally different timings. When it is expressed that a first frame, a second frame, and the like are transmitted or received at temporally different points, the expression of the first, the second, and the like is just an expression for distinguishing the frames, and the types and the content of the frames may be the same or different.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

1. A wireless communication device comprising:
a receiver and
a transmitter:
the receiver is configured to receive N pieces of first data transmitted by N terminals in a multiplexed manner;
combine a piece of second data with one of the N pieces of first data to generate combined data;
decode the N pieces of first data by using N decode processors selected from among M decode processors where M is an integer larger than N; and
decode the combined data by using a first decode processor, among the M decode processors, other than the N decode processors.

2. The wireless communication device according to claim 1, wherein
a part of the pieces of first data transmitted by first terminals being a part of the N terminals is retransmitted data of pieces of second data, and
the receiver is configured to combine the pieces of second data with the part of the pieces of first data to generate pieces of combined data, and decode the pieces of the combined data by using first decoders.

3. The wireless communication device according to claim 2, wherein
the transmitter is configured to transmit information designating the N terminals including the first terminals, and
the receiver is configured to receive the plurality of pieces of first data transmitted in the multiplexed manner by the N terminals including the first terminals.

4. The wireless communication device according to claim 3, further comprising a controller configured to determine a value of the N in accordance with a quantity of first terminals, and
the value of N is equal to or smaller than a value subtracted from M by the quantity of the first terminals.

5. The wireless communication device according to of claim 1, wherein
the receiver is configured to decode pieces of likelihood information each of which corresponds to a different one of the plurality of pieces of first data, by using the N decode processors,
the receiver is configured to combine likelihood information of pieces of second data with likelihood information corresponding to a part of the pieces of first data to generate pieces of combined likelihood information, and
the receiver is configured to decode the pieces of combined likelihood information by using first decode processors.

6. The wireless communication device according to claim 1, wherein
the receiver is configured to combine X pieces of second data with X pieces of first data among the N pieces of first data to generate X pieces of combined data, where X is an integer of 2 or larger, and
the receiver is configured to decode the X pieces of combined data by using X first decode processors, among the M decode processors, other than the N decode processors.

7. The wireless communication device according to claim 1, comprising at least one antenna.

8. A wireless communication method comprising:
receiving N pieces of first data transmitted by N terminals in a multiplexed manner;
combining a piece of second data with one of the N pieces of first data to generate combined data;
decoding the N pieces of first data by using N decode processors selected from among M decode processors where M is an integer larger than N; and
decoding the combined data by using a first decode processor, among the M decode processors, other than the N decode processors.

9. The wireless communication method according to claim 8, wherein
a part of the pieces of first data transmitted by first terminals being a part of the N terminals is retransmitted data of pieces of second data, and
the method comprising: combining the pieces of second data with the part of the pieces of first data to generate pieces of combined data; and decoding the pieces of the combined data by using first decoders.

10. The wireless communication method according to claim 9, wherein
the method comprising: transmitting information designating the N terminals including the first terminals, and
receiving the plurality of pieces of first data transmitted in the multiplexed manner by the N terminals including the first terminals.

11. The wireless communication method according to claim 10, further comprising determining a value of the N in accordance with a quantity of first terminals, and
wherein the value of N is equal to or smaller than a value subtracted from M by the quantity of the first terminals.

12. The wireless communication method according to of claim 8, further comprising:
decoding pieces of likelihood information each of which corresponds to a different one of the plurality of pieces of first data, by using the N decode processors,
combining likelihood information of pieces of second data with likelihood information corresponding to a part of the pieces of first data to generate pieces of combined likelihood information, and
decoding the pieces of combined likelihood information by using first decode processors.

13. The wireless communication method according to claim 8, further comprising:
combining X pieces of second data with X pieces of first data among the N pieces of first data to generate X pieces of combined data, where X is an integer of 2 or larger, and
decoding the X pieces of combined data by using X first decode processors, among the M decode processors, other than the N decode processors.
